(19) United States
(12) Patent Application Publication
(10) Pub. No.: US 2024/0338902 A1
(43) Pub. Date: Oct. 10, 2024

(54) AUGMENTED REALITY COMPARATOR

(71) Applicant: Shopify Inc., Ottawa (CA)

(72) Inventors: Russ Maschmeyer, Berkeley, CA (US); Eric Andrew Florenzano, San Francisco, CA (US); Brennan Letkeman, Calgary (CA); Diego Macario Bello, Montreal (CA); Daniel Beauchamp, Toronto (CA)

(73) Assignee: Shopify Inc., Ottawa (CA)

(21) Appl. No.: 18/298,101

(22) Filed: Apr. 10, 2023

(51) Int. Cl. G06T 19/00; G06F 3/01; G06V 10/44; G06V 10/74

(52) U.S. Cl. CPC G06T 19/006; G06F 3/017; G06V 10/44; G06V 10/761; G06V 2201/07

(57) ABSTRACT

Described herein are systems and methods for generating AR-enriched media feeds for comparing attributes of objects. A user operates an AR device to collect or extract object information in a media feed including a current object. The AR device identifies a comparison object using attributes of the current baseline object. After the comparison object has been identified, the AR device generates and presents an AR overlay in the graphical user interface that shows the selected attribute of the comparison object nearby or on top of the attribute of the current object in the real time media feed containing the current object.

### TECHNICAL FIELD

This application relates generally to dynamically generating media data feeds and presenting graphical user interfaces, and, more particularly, to identifying attributes of objects and comparing attributes of objects in augmented reality (AR) or virtual reality (VR).

### BACKGROUND

Augmented reality (AR) relates to the enhancement of real-world experiences using computer-generated or virtual content. In some cases, AR enables a user to visualize or otherwise interact with an environment that involves both real-world and virtual components. For example, AR may present three-dimensional (3D) visuals of real-world and virtual objects to a person, as though the objects were situated nearby one another.

### BRIEF DESCRIPTION OF THE DRAWINGS

The accompanying drawings constitute a part of this specification and illustrate embodiments of the subject matter disclosed herein.

FIG. 1 illustrates components of a system for hosting AR/VR functions for client devices, according to an embodiment.

FIG. 2 illustrates components of a system offering dynamic object presentation, according to an embodiment.

FIG. 3 illustrates operations of a method for generating an AR/VR-enriched user interface displaying object comparisons, according to an embodiment.

FIG. 4 illustrates operations of a method for generating an AR/VR-enriched user interface displaying object comparisons, according to an embodiment.

FIGS. 5A-5B illustrates components of a system that generates AR/VR-enriched user interfaces for comparing products, according to an embodiment.

FIG. 6A illustrates components of a system hosting or interacting with an e-commerce platform, according to one embodiment.

FIG. 6B illustrates a home page of an administrator, according to the embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

While a person is looking at an object in the person's proximity, the person may desire to compare properties or criteria of that object with those of another object. AR may present three-dimensional (3D) visuals of the objects to the person, as though the objects were situated nearby one another. The comparison may be based on criteria such as, e.g., nutritional facts (where, e.g., the objects are two food items in a supermarket) or dimensions (where, e.g. the objects are two different vehicles).

Conventional AR functions may enhance a user's experience by overlaying information about a product within an AR-enhanced graphical user interface, but do not provide comparable information of two or more products. Presenting too much information at the graphical user interface could be disadvantageous to processing resources and detrimental to the user experience. It may be desirable to provide a comparison of only certain criteria to a customer. For example, rather than listing all facts for two food products being compared, it may be desirable to present the nutritional facts for the two food products being compared, and it may be desirable to present only certain criteria such as amount of protein or sugar in those products.

The solutions herein may dynamically present, detect, or alter AR information by identifying or inferring comparable types of data between objects or products. The solutions herein may continually monitor and detect attributes or features for comparison of a first item (e.g., product, object) against a second item, and presenting an AR/VR-enriched user interface displaying the comparison of the attributes.

The user may utilize an AR device (e.g., smartphone, tablet, laptop, VR headset) to collect data about objects in the view of an optical sensor of the AR device. The data may include attribute data, which may also be inferred by the AR device. For example, as the user walks around a supermarket, the AR device will collect images of objects (e.g. products) and obtain and/or infer attribute data of those objects by applying an object recognition engine trained to detect certain attributes.

When the user is viewing a current object using the AR device, the user may desire to compare it to an earlier-viewed object or known, comparable object stored in one or more databases. The user may provide, for example, a verbal (audio) instruction to compare an attribute of the current object to a comparison object, or the customer may utilize a gesture (e.g., pointing, holding both objects, eye gaze, zoom on feature) that is recognized by the AR device to trigger a comparison. The instruction may include an attribute selected by the customer for comparison (e.g., nutrition, dimensions).

In some embodiments, the AR device may identify a comparison object based upon attribute data of the current object and attribute data of the earlier-viewed objects. For example, the AR device may identify that the current object is a granola bar and a comparison object also has attribute data of a granola bar. In another example, the AR device may identify the current object as a hatchback car and a comparison object as a hatchback car. The attribute data may include geolocation data, such as a supermarket location or a car dealership lot. The AR device may utilize an AI engine to infer what qualifies as a comparison object (e.g., based on extracted text, dimensions, colors).

Once the comparison object has been identified, the AR device presents an AR overlay in the graphical user interface that shows the selected attribute of the comparison object near or on top of the attribute of the current object. For example, the GUI may present a nutritional fact of the comparable object near the nutritional fact of the current object. In another example, the GUI may present a trunk dimension representation of the comparison vehicle on top of the currently-viewed vehicle. The AR device may utilize an AI engine to infer an attribute of the current object and/or the comparison object.

### Example System Components

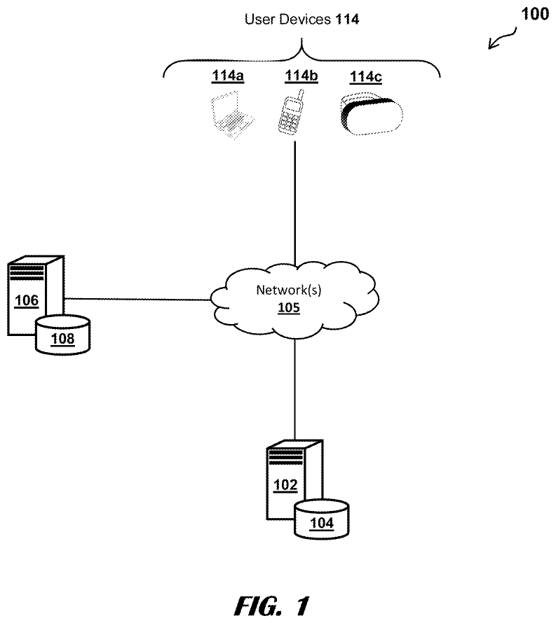

FIG. 1 shows components of a system 100 for comparing objects through AR/VR presentations provided to graphical user interfaces of user devices 114, according to an embodiment. The system 100 includes application servers 102, application databases 104, user devices 114a-114c (generally referred to as “user devices 114” or a “user device 114”), provider servers 106, and provider databases 108. The various devices of the system 100 may communicate with one another via one or more networks 105.

For case of description and understanding, FIG. 1 depicts the system 100 as having only one or a small number of each component. Embodiments may, however, comprise additional or alternative components, or omit certain components, from those of FIG. 1 and still fall within the scope of this disclosure. As an example, it may be common for embodiments to include multiple application servers 102 and/or multiple provider servers 106. Embodiments may include or otherwise implement any number of devices capable of performing the various features and tasks described herein. For instance, FIG. 1 depicts the application database 104 as hosted as a distinct computing device from the application server 102, though, in some embodiments, the application server 102 may include an integrated application database 104 hosted by the application server 102.

The networks 105 interconnect the components of the system 100, hosting and facilitating communications between the various devices of the system 100. The network 105 may include any number of public and/or private networks. The network 105 may comprise hardware and software components implementing various network and/or telecommunications protocols facilitating communications between the various devices, which may include devices of the system 100 or any number of additional or alternative devices not shown in FIG. 1. The network 105 may be implemented as, for example, a cellular network, a Wi-Fi network, or other wired local area networks (LAN) or wireless LAN, a WiMAX network, or other wireless or wired wide area network (WAN), and the like.

The user devices 114 may be any type of electronic device comprising hardware components (e.g., processor, non-transitory storage) and software components capable of performing the various processes and tasks described herein. Non-limiting examples of the user device 114 include personal computers 114a (e.g., laptop computers, desktop computers), mobile devices 114b (e.g., smartphones, tablets), VR devices 114c, and gaming consoles, among other types of electronic devices.

The VR device 114c may be any electronic device that generates and presents the AR/VR-enriched user interface to the user. In some embodiments, the VR device 114c may be a distinct, standalone electronic device capable of performing the various functions and features described herein, including, for example, software for generating the graphical user interface, processing user commands and performing functions in accordance with the user inputs, and processing data and instructions received from the application server 102 for updating the graphical user interface or performing other functions. In some embodiments, the VR device 114c may be coupled to another user device 114 (e.g., personal computer 114a, gaming console) via a wired or wireless connection. In these embodiments, the VR device 114c provides the functionality for presenting the AR/VR-enriched user interface, but utilizes data communications and/or processing functions of the other user device 114, which may communicate data and instructions with the application server 102 and/or execute various software routines for processing data.

The user device 114 may execute a browser and/or client-side software application that accesses services and data of the application server 102 and generates the AR/VR user interface based upon the user commands from the user and the data or instructions received from the application server 102. Non-limiting examples of operations performed by the user device 114 when executing the browser or local application include: processing user inputs received from the graphical user interface; processing media data captured by a camera (or other type of optical sensor of the user device 114); preparing information (e.g., user-entered queries, user information) for transmission over the network 105 to the application server 102 or provider server 106; processing the data or the instructions received over the network 102 from other devices (e.g., application server 102, provider server 106) of the system 100; and instructing a display screen of the user device 114 to display output information on the AR/VR user interface, among other types of functions.

In some cases, the user device 114 may transmit an object request or comparison request according to a command entered by the user attempting to compare two objects in a visual representation of the objects within the AR/VR graphical user interface. The user device 114 may transmit the object request to the application server 102 or the provider server 106. The request includes a query for object data corresponding to the objects indicated by the object request. The object data may be publicly available over the Internet or privately stored in the one or more databases 104, 108. The request may instruct the application server 102 or the provider server 106 to query the Internet or the one or more databases 104, 108 of the system 100 for the object data (e.g., publicly available technical specifications, privately stored product or inventory information) corresponding to the objects indicated by the object request.

The object data may include various types of data about various types of objects, such as object attributes (e.g., dimensions, colors), object information that include textual descriptors for aspects of the object, and/or object media data (e.g., digital media files, virtual representations of the object for the AR/VR graphical user interface). The object data stored in the databases 104, 108 may include comparative attribute mappings for various types of attributes, where the attribute mappings contain indicators that logically map (or correlate) objects having a particular attribute against other objects having the same or comparable attribute, as indicated in the object data in the databases 104, 108 or other data source (e.g., public webpage). In operation, the user device 114 may submit one or more requests for the object data of a particular object and for the object data of one or more comparison objects. In some cases, the application server 102 (or the local software of the user device 114) may reference pre-stored attribute mappings and/or generate new attribute mappings, which the application server 102 may reference to identify the comparison object. In some embodiments, the application server 102 or the user device 114 may execute software programming for recognizing or identifying the attributes of the objects, identifying comparison objects or comparison attributes, and generating data for display at the user interface of the user device 114, among others.

The user device 114 may access the object data from an application database 104 via the application server 102, or a provider database 108 via the provider server 106. The user device 114 may, for example, visit a service provider's website hosted by the provider server 106, by executing the particular software program of the user device 114 (e.g., browser, locally installed application). The provider's website may include one or more features hosted (or otherwise produced or functionally controlled) by the provider server 106 or by application server 102. For instance, the application server 102 may host a centralized service platform that authenticates the user for the provider server 106 and forwards the user's requests for the object data to the provider server 106. In some implementations, the application server 102 may perform various additional services on behalf of the service providers and the users, such as: authenticating the users or devices of the system 100; conducting transactions between the users and the service providers; storing and managing object data in the one or more databases 104, 108, or otherwise accessible to the user devices 114 via the application server 102 or the provider server 106; generating and managing visual features or object data displayed at that graphical user interface; and processing or forwarding the requests for object data or visual features from the user devices 114, among any number of additional or alternative operations. Additionally or alternatively, in some implementations, the user device 114 includes non-transitory media that may store application-related data (e.g., object data) or user data. The user device 114 may store, for example, the object data and/or attribute mappings for various types of attributes, mapping objects with a particular attribute to other objects having the same or comparable attribute.

The application server 102 or the software executed by the user device 114 may include a spatially aware media engine or similar software programming for generating an AR/VR display using the media data. The spatially aware media engine analyzes the media data of the physical space of the real-world location to identify or generate visual attributes. The spatially aware media engine may, for example, generate a 3D coordinate system for the physical space of the real-world location and recognize visual attributes. Non-limiting examples of the visual attributes generated or recognized by the spatially aware media engine may include contours, surfaces, barriers defining dimensions of the physical space, and objects situated in the physical space. The user device 114 or the application server 102 may include an object recognition engine of a machine-learning architecture. The object recognition engine is trained to recognize various objects in the media data captured by the camera of the user device 114. In some cases, the object recognition engine may recognize spatial attributes of the physical space captured by the camera, and the spatial attributes may be used or generated by the spatially aware media engine for generating the AR-enriched graphical user interface.

The spatially aware media engine analyzes the media data of the physical space of the real-world location to identify or generate visual attributes. The spatially aware media engine may, for example, generate a 3D coordinate system for the physical space of the real-world location and recognize visual attributes. Non-limiting examples of the visual attributes generated or recognized by the spatially aware media engine may include contours, surfaces, barriers defining dimensions of the physical space, and objects situated in the physical space.

In some embodiments, the user device 114 executes AR software programming that generates the augmented AR-enriched media data feed presented to the user via the graphical user interface. For the AR operations, the user device 114 may activate the camera (or other optical sensor) to generate the ongoing video feed, which the user device 114 augments to include virtualized AR overlays as virtual representation(s) of certain portions of the object data, such as certain object information (e.g., images, text) or a virtual representation of the object (sometimes referred to as a “virtual object”).

The overlays may include, for example, virtual objects of objects or object attributes. A comparison engine or other software component of the user device 114 or application server 104 may determine where to situate the overlay in the AR-enriched graphical user interface based upon the user instructions and/or a coordinate system. The comparison engine or the spatially aware engine may, for example, determine a set of coordinates for position the AR overlay within the coordinate system of the media data, which the spatially aware engine generated and mapped for the physical space in the media data captured by the camera. Additionally or alternatively, the user device 114 or application server 102 may pin or anchor the AR overlay within the coordinate system, such that the coordinates may be relative to a certain portion or attribute (e.g., object or surface) that the machine-learning architecture recognized in the visual image data captured by the camera. For instance, the user device 114 or application server 102 may pin or anchor a virtual wiremesh showing contours of a physical real-world space (e.g., trunk of a car, room) to a set of relative coordinates recognized in the coordinate system of the physical space. As the camera moves around the physical space and changes perspective, the AR overlay (e.g., virtual wiremesh, virtual object) may remain pinned to the particular set of relative coordinates within the media feed, thereby maintaining the wiremesh or object presented to the graphical user interface that is persistent even when the user redirects the camera's field of view.

The application server 102 and the merchant server 106 may be any computing device that comprises a processor and non-transitory machine-readable storage media, and capable of executing the various processes and tasks described herein. Non-limiting examples of the servers 102, 106 may include desktop computers, laptop computers, and tablet devices, among others. In some cases, the application server 102 may store or otherwise contain the computer-executable software instructions, such as instructions needed to execute the spatially aware media engine, object rejection engine, and comparison engine, among others. The software and hardware components of the application server 102 enable the application server 102 to perform various operations that serve particular functions for the user device 114 to query or access data provided by the provider server 106 and/or provider database 108.

The application server 102 may execute webserver software (e.g., Apache®, Microsoft IIS®) enabling the application server 102 to execute functions for hosting a website or web app, allowing the users to interact with the services and functions provided by the application server 102 and/or the provider server 106. In some cases, for example, the application server 102 may instruct the provider server 106 to query the provider database 108 for object data in response to a request from the user device 114 or instruct the provider server 106 to interact with the user device 114 by sending the object data to the user device 114.

The user device 114 or the application server 102 may execute the spatially aware media engine that directly or indirectly generates AR overlays or other visual objects for media feed data presented to the AR/VR-enriched graphical user interface. The spatially aware media engine may generate instructions for the user device 114 to generate the AR-enriched media data and the AR/VR-enriched graphical user interface. The user device 114 may use these instructions to generate and display the graphical user interface to the user. The application server 102 or user device 114 may perform various software processes for processing the image data for physical spaces and/or generating AR-enriched media feed data. Such software processes may include the various layers of the machine-learning architecture for object recognition or computer vision, such as object classification (e.g., object recognition engine) and spatial awareness within the coordinate system of the physical space (e.g., spatially aware media engine). As an example, for a particular physical space, the user device 114 (or application server 102) may recognize attributes of the physical space, such as the dimensions, colors, and barriers (e.g., walls, half-walls, doorways, windows) in the media data received from the camera of the user device 114. In some implementations, the spatially aware media engine analyzes the media data of a physical space to, for example, generate a 3D coordinate system for the physical space, recognize or fetch attributes (e.g., people, objects, surfaces) in the physical space, maps the attributes to the coordinate system, pins or anchors attributes to the coordinate system, and apply the AR overlays or other virtual representations, among other potential functions.

In some embodiments, the application server 102 may receive media data or other instructions or object data from the user device 114, which the application server 102 may process using various machine-learning architecture operations. The application server 102 may perform various processes that ingest the media data and apply the layers of a machine-learning architecture defining a computer vision and/or object recognition engine to identify attributes of the physical space and recognize objects. The application server 102 may generate and return the virtual representations, object information, or comparison object information. The application server 102 may also generate or update database records of the application database 104 containing object data, as received from the user device 114 or provider server 106.

The application database 104 or other non-transitory storage memory of the system 100 (e.g., user device 114, provider server 106, provider database 108) may store data records for objects. The data records include various object data, which includes various types of data and information, in various data formats. The object data may be pre-configured and updated automatically by the application server 102 or provider server 106 when new objects are entered by users into the databases 104, 108 or identified by the user devices 114. In some implementations, the application database 104 or user device 114 stores object data for the objects previously-viewed by the user device 114, such that the user device 114 or other device continually or responsively captures and stores object data for objects that the user includes in the requests or identifies using the camera. In some implementations, the user device 114 or other device may continually capture imagery and generate media data for objects in the field of view of the camera. The user device 114 may also continually apply the object recognition engine on the image data for the plurality of current objects to identify the object, and, in some cases, extract attributes or other object data for the current object.

### Example Networked Components of System

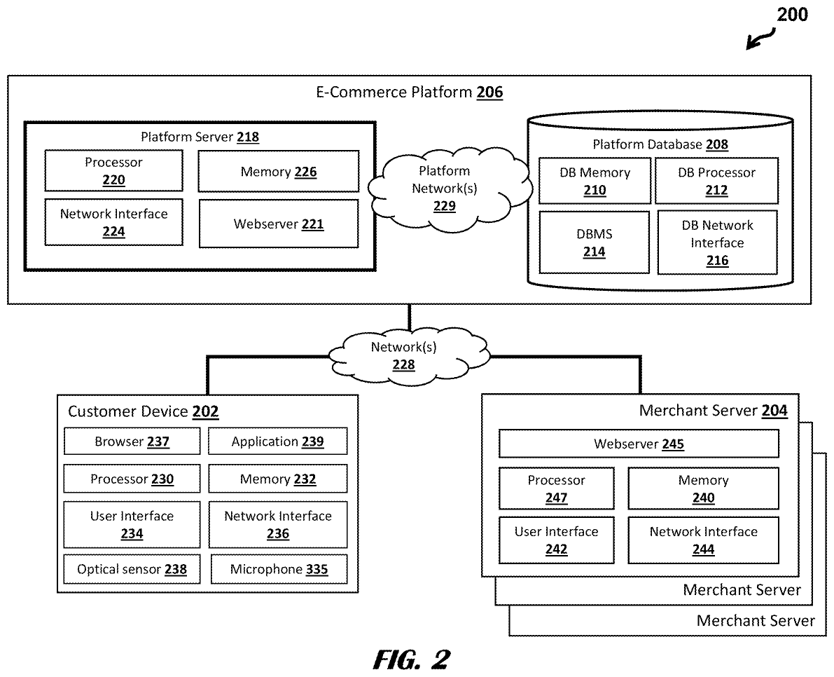

FIG. 2 illustrates components of a system 200 offering dynamic, comparative, AR/VR presentations of products, according to an embodiment. The system 200 includes various hardware and software components including customer devices 202 (e.g., user devices 114), merchant servers 204 (e.g., provider servers 106), and computing devices of an e-commerce platform 206, including a platform server 218 (e.g., application server 102) and platform database 208 (e.g., platform database 104). For case of description and understanding, FIG. 2 depicts the system 200 as having only one or a small number of each component. However, embodiments may include any number of the components described herein. Moreover, embodiments may comprise additional or alternative components, or may omit certain components, and still fall within the scope of this disclosure. It should be understood that the e-commerce platform 206 is only one possible example of an online platform and is not intended to be limiting. The present disclosure may be implemented in other contexts, and is not necessarily limited to implementation in an e-commerce platform 206, customer device 202, and merchant servers 204, but may include any type of computing devices hosting cloud-based data-transaction services, any type of end-user devices, and any type of devices hosting third-party services.

One or more networks 228 interconnect the customer devices 202, the merchant servers 204, and the e-commerce platform 206, such that the network 228 facilitates communications between the devices of the system 200. The network 228 may include any number of public and/or private networks. The network 228 may comprise hardware and software components implementing various network and/or telecommunications protocols facilitating communications between various devices, which may include devices of the system 200 or any number of additional or alternative devices not shown in FIG. 2. The network 228 may be implemented as a cellular network, a Wi-Fi network, or other wired local area networks (LAN) or wireless LAN, a WiMAX network, or other wireless or wired wide area network (WAN), and the like. The network 228 may also facilitate communications with external servers of other external services coupled to the network 228, such as the merchant server 204 or servers hosting a social media platform, a banking platform, a fashion or design service platform, a teleconferencing platform, or other types of cloud-based platform services. The network 228 may include any number of security devices or logical arrangements (e.g., firewalls, proxy servers, DMZs) to monitor or otherwise manage web traffic to the e-commerce platform 206. Security devices may be configured to analyze, accept, or reject incoming web requests from the customer device 202, the merchant server 204, and/or the customer device 202. In some embodiments, the security device may be a physical device (e.g., a firewall). Additionally or alternatively, the security device may be a software application (e.g., Web Application Firewall (WAF)) that is hosted on, or otherwise integrated into, another computing device of the system 200. The security devices monitoring web traffic are associated with and administered by the e-commerce platform 206.

The customer device 202 may be any type of electronic device comprising hardware and software components capable of performing the various processes and tasks described herein. Non-limiting examples of the customer device 202 include smartphones, laptops, tablets, workstation computers, gaming consoles, VR devices, or server computers, among other types of electronic devices. As shown in the system 200, the customer device 202 may further store various types of user data, such as data generated or referenced by the application 239. The customer device 202 may include a customer processor 230, customer memory 232, customer graphical user interface 234, and one or more customer network interfaces 236. The customer device 202 may execute a browser 237 and/or client-side software application 239 to access services of the e-commerce platform 206 or the merchant server 204.

The processor 230 customer processor 230 directly performs or instructs all of the operations performed by the customer device 202, which the customer processor 230 may accomplish in some embodiments according to instructions and control from an operating system of the customer device 202. Non-limiting examples of these operations include: processing customer inputs received from the customer user interface 234; processing media data captured by the camera (or other optical sensor 238) or the microphone 235; preparing information for transmission over the network 228; processing data or instructions received over the network 228 from other devices of the system 200; and instructing a display screen to display information, among others. The customer processor 230 may be implemented by one or more processor devices that execute instructions stored in the customer memory 232. Alternatively, some or all of the customer processor 230 may be implemented using dedicated circuitry, such as an ASIC, a GPU, or a programmed FPGA. The memory 232 includes any type of non-transitory machine-readable storage that stores machine-executable software programming, such as the browser 237 or application 239. Additionally or alternatively, the memory 232 may store application-related data or user data. The memory 232 may include, for example, product information for products and/or attribute mappings for various types of attributes, mapping products with a particular attribute to other products having the same or comparable attribute.

The network interface 236 may include hardware and software enabling the customer device 202 to communicate via the network 228. The structure of the network interface 236 will depend on how the customer device 202 interfaces with the network 228. For example, if the customer device 202 is a mobile phone or tablet, the network interface 236 may include a transmitter, receiver, or transceiver with an antenna for sending and receiving wireless transmissions to or from the e-commerce platform 206 or merchant server 204 via the network 228. The customer device 202 may connect physically to the network 228 via a network cable or other interfacing hardware components compatible with the network interface 236. The network interface 236 may include, for example, a network interface card (NIC), a computer port, and/or a network socket. The customer device 202 may include any number of network interfaces 236 for communicating via different channel mediums and protocols. For example, the customer device 202 may include hardware and software for communicating TCP/IP data packets with computing devices of the system 200 via wired LANs or wireless LANs; and may further include hardware and software for wirelessly communicating Bluetooth® data packets with other computing devices, such as wireless beacons (not shown).

When communicating with components of the e-commerce platform 206, the customer device 202 may generate web traffic (or web session data) that is processed by or otherwise accessible to the platform server 218 of the e-commerce platform 206. The web traffic may comprise data packets that include various types of data that can be parsed, analyzed, or otherwise reviewed by various programmatic algorithms of the platform server 218. For instance, the web traffic data may indicate or request certain types of data being accessed by software of the customer device 202 and/or by the customer operating the customer device 202. As an example, the customer device 202 submits a request for product information for one or more comparison products. The customer device 202 accesses the product information from the platform database 208 or a merchant's online store by either visiting a website of the merchant hosted by the merchant server 204 using the browser 237 or executing the application 239. In some implementations, the merchant's online store may include one or more features hosted (or otherwise produced or functionally controlled) by the platform server 218. For instance, the platform server 218 may revise one or more features (e.g., product information) displayed on, or accessible through, the merchant's online store. The browser 237 and/or the application 239 may transmit and receive data packets to display various features of the merchant's online store on a graphical user interface 234.

The browser 237 may include a software program (e.g., Google Chrome® Microsoft Internet Explorer®) executed by the customer device 202 for accessing a website or cloud-application hosted by the platform webserver 221 or merchant webserver 245. The browser 237 navigates to the platform webserver 221 or merchant webserver 245 according to a Uniform Resource Locator (URL) or other type of addressing identifier, accesses machine-readable code (e.g., html, php, javascript) of the webpage, and executes machine-readable instructions according to the webpage code. For instance, the webpage code may instruct the browser 237 to generate and display elements of the webpage as an interactive graphical user interface, which may be displayed via the customer user interface 234. An example of the customer user interface 234 may include the visual elements of the webpage and/or a physical display screen (e.g., touchscreen) of the customer device 202. By operating the browser 237, the customer may navigate the webpages hosted by the platform webserver 221 or merchant webserver 245 to interact with, and configure, the services or products offered by the e-commerce platform 206 or the merchant's online store.

The application 239 may include a software program published by or otherwise associated with the e-commerce platform 206 or the merchant's online service, and installed on the customer memory 232 of the customer device 202. The customer processor 230 of the customer device 202 may execute the application 239, which remotely accesses the data and/or functional services hosted by the platform server 218 or the merchant server 204, such as a cloud-based software application. The application 239 transmits requests or instructions to the platform server 218 or merchant server 204 as the user operates the application 239. Using the data or instructions received from the platform server 218 or merchant server 204, the application 239 may generate and display elements of an interactive graphical user interface within the application 239, which the application 239 instructs the customer device 202 to display as the customer user interface 234. By operating the application 239, the customer may access the cloud-application hosted by the platform webserver 221 or merchant webserver 245, to interact with, and configure, the services or products offered by the e-commerce platform 206 or the merchant's online services.

The customer device 202 and processor 230 are associated with various I/O devices, such as an optical sensor 238 or microphone 235. The I/O device may be integrated into the same electronic device (e.g., customer device 202) as the processor 230, or the I/O device may be coupled to the processor 230 via one or more wired or wireless communication links (e.g., USB wire, Bluetooth wireless) that connects the particular I/O device with the customer device 202. As shown in the system 200, the customer device 202 may include one or more optical sensors 238 and a microphone 235, which may generate various types of media data (e.g., audio data, image data, video data, audiovisual data). As mentioned, the customer user interface 234, optical sensor 238, and microphone 235 need not be integrated components of the customer device 202. For instance, in some embodiments, the customer device 202 may connect to the optical sensor 238 via a USB cable such that the processor 230 receives and processes the media data from the optical sensor 238 via the USB cable.

The optical sensors 238 may include any type of sensor device that captures optical information and generates the media data containing the optical information by converting light rays into electronic signals and binary data. Non-limiting examples of the optical sensors 238 may include a camera, LIDAR sensor, and a light sensor, among others. In operation, an operating system of the customer device 202 may provide media data captured by the optical sensor 238 and/or microphone 235 of the customer device 202 to the browser 237, thereby allowing the browser 237 to generate and transmit a media stream to a receiving device, such as the platform server 218, merchant server 204, and/or one or more customer devices 202.

The customer device 202 includes a user interface 234 comprising hardware (e.g., monitor, screen, touchscreen) and software components that displays various types of outputs based on, for example, instructions from the browser 237, the application 239, and/or from an operating system of the customer device 202. As an example, the operating system receives and processes media data captured by an optical sensor 238 of the customer device 202, and provides the media data to the network interface 236 such that the user interface 234 displays the media data captured by the optical sensor 238.

One or more devices of the system 200 execute software programming that perform various processes, such as recognizing or identifying attributes of products, identifying comparison products or attributes, and generating data for display at the user interface 234 of the customer device 202, among others. In some cases, the application 239 executes some or all of the processes using the media data received from the optical sensor 238 or other types of data. In some cases, the platform server 218 some or all of the processes using various types of data inputs received from the browser 237, such as media data.

The processes of the application 239 or the platform server 218 may include a spatially aware media engine or similar software programming for generating an AR/VR display using the media data. The spatially aware media engine analyzes the media data of the physical space of the real-world location to identify or generate visual attributes. The spatially aware media engine may, for example, generate a 3D coordinate system for the physical space of the real-world location and recognize visual attributes. Non-limiting examples of the visual attributes generated or recognized by the spatially aware media engine may include contours, surfaces, barriers defining dimensions of the physical space, and objects situated in the physical space.

The processes of the application 239 or the platform server 218 may include an object recognition engine of a machine-learning architecture. The object recognition engine is trained to recognize various objects in the media data captured by the optical sensor 238. In some cases, the object recognition engine may recognize spatial attributes of the physical space captured by the optical sensor 238, and the spatial attributes may be used or generated by the spatially aware media engine for generating the AR-enriched graphical user interface.

As an example, in some embodiments, the platform server 218 or customer device 202 may execute software programming (e.g., media engine, application 239) that apply various layers or components of a machine-learning architecture on the media data to generate an augmented reality (AR) representation of the physical space of the real-world location in the view of the optical sensor 238. The platform server 218 may generate a 3D coordinate system using the various types of media data received from the optical sensor 238 and/or user inputs. The software processes of the platform server 218 or customer device 202 may generate 3D coordinates for recognized objects or obfuscations that map the recognized objects or obfuscations to the 3D coordinate system generated for the real-world location. The spatially aware media engine of the platform server 218 or the customer device 202 may pin or anchor virtual overlays (e.g., physical features of objects or space, virtual obfuscations, virtual objects) to coordinates of objects or user-inputted coordinates such that the overlays remain dynamic and persist, even when the feature or virtual overall is not captured by a current field-of-view of the optical sensors 238.

Using the browser 237 or the application 239, the customer may enter configurations into the customer user interface 234 that configure the functions and services provided by the e-commerce platform 206, the merchant online store, and/or the application 239. The customer device 202 may store for the application 239 or transmit the configurations to the platform server 218 or merchant server 204. The configuration inputs indicate customer preferences and include instructions for configuring the customer's experience for the services provided by the e-commerce platform 206 or the merchant's online service, and/or configuring the operations of devices and software components of the system 200. The configuration inputs may include triggering instructions for invoking processes of the application 239 or platform server 218, such as the object recognition engine, selection engine, or comparison engine. Non-limiting examples of the triggering instructions include user inputs entered at the customer device 202 or user gestures detected in the media data, among others.

In some embodiments, the application 239 of the customer device 202 executes the augmented reality (AR) software programming that generates the augmented AR-enriched media data feed transmitted to the merchant server 204 or other receiving device or presented to the customer via the graphical user interface 234. For the AR operations, the customer device 202 may activate the optical sensor 238 to generate the ongoing video feed from the optical sensor 238, which the customer device 202 augments to include virtualized AR overlays as virtual representation(s) of product information (e.g., images, text) of the products.

The overlays may include, for example, virtual objects of products or product attributes (e.g., image of nutrition panel on jar of food). A comparison engine or other software component of the customer device 202 may determine where to situate the overlay based upon the user instruction. The comparison engine or the spatially aware engine may, for example, determine a set of coordinates for position the AR overlay within a coordinate system of the media data, which the spatially aware engine generated and mapped for the physical space in the media data captured by the optical sensor 238. Additionally or alternatively, the customer device 202 or platform server 218 may pin or anchor the AR overlay within the coordinate system, such that the coordinates may be relative to a certain portion or attribute (e.g., object or surface) that the machine-learning architecture recognized in the visual image data captured by the optical sensor 238. For instance, the customer device 202 or platform server 218 may pin or anchor a virtual wiremesh showing contours of a physical real-world space (e.g., trunk of a car, room) to a set of relative coordinates recognized in the coordinate system of the physical space. As the optical sensor 238 moves around the physical space and changes perspective, the AR overlay (e.g., virtual wiremesh, virtual object) may remain pinned to the particular set of relative coordinates within the media feed, thereby maintaining the wiremesh or object presented to the user interface 234 that is persistent even when the customer redirects the optical sensor 238 field of view.

The e-commerce platform 206 is a computing system infrastructure that may be owned and/or managed (e.g., hosted) by an e-commerce service and, in some embodiments, may be the same as or similar to that described with reference to other embodiments or drawings herein (e.g., FIGS. 1 and 6-7), though this need not be the case. The e-commerce platform 206 includes electronic hardware and software components capable of performing various processes, tasks, and functions of the e-commerce platform 206. For instance, the computing infrastructure of the c-commerce platform 206 may comprise one or more platform networks 229 interconnecting the components of the e-commerce platform 206. The platform networks 229 may comprise one or more public and/or private networks and include any number of hardware and/or software components capable of hosting and managing the networked communication among devices of the e-commerce platform 206.

As depicted in FIG. 2, the components of the e-commerce platform 206 include the platform server 218 and platform database 208. However, the embodiments may include additional or alternative components capable of performing the operations described herein. In some implementations, certain components of the e-commerce platform 206 may be embodied in separate computing devices that are interconnected via one or more public and/or private internal networks (e.g., network 228, platform network 229). In some implementations, certain components of the e-commerce platform 206 may be integrated into a single device. For instance, the platform server 218 may host the platform database 208. Furthermore, the e-commerce platform 206 may include the platform server 218 configured to serve various functions of the e-commerce platform 206. Non-limiting examples of such functions may include the software functions of the platform webserver 221 hosting webpages and applications (or at least a portion of a webpage or cloud-application) on behalf of merchants (e.g., merchants' online stores), security servers executing various types of software for monitoring web traffic (e.g., determining that a customer has accessed an electronic platform hosted by the merchant server 204), and database servers hosting various platform databases 208 of the e-commerce platform 206, among others.

The illustrative e-commerce platform 206 is shown and described as having only one platform server 218 performing each of the various functions of the e-commerce service. For instance, the platform server 218 is described as serving the functions of executing a spatially aware media engine and a webserver 221 hosting webpages for merchants' online stores and account administration. It is intended that FIG. 2 is merely illustrative a potential use case for AR/VR comparison functions and features, and that embodiments are not limited to the description of the system 200 or the particular configuration shown in FIG. 2. The software and hardware of the platform server 218 may be integrated into a single distinct physical device (e.g., a single platform server 218) or may be distributed across multiple devices (e.g., multiple analytics servers 218). In some implementations, the platform server 218 may be a virtual machine (VM) that is virtualized and hosted on computing hardware configured to host any number of VMs. Some operations may be executed on a first computing device while other operations may be executed on a second computing device, such that the functions of the platform server 218 are distributed among the various computing devices. For instance, some operations may be executed on the customer device 202 and others may be executed by the platform server 218, such that the workload and functionality are distributed between or otherwise result from execution by various devices of the system 200.

The platform server 218 may be any computing device that comprises a processor 220 and non-transitory machine-readable storage media (e.g., server memory 226) and that is capable of executing the software for one or more functions such as the spatially aware media engine. Non-limiting examples of the platform server 218 may include desktop computers, laptop computers, and tablet devices, among others. In some cases, the server memory 226 may store or otherwise contain the computer-executable software instructions, such as instructions needed to execute the spatially aware media engine, object rejection engine, and product comparison engine, among others. The software and hardware components of the platform server 218 enable the platform server 218 to perform various operations that serve particular functions of the e-commerce platform 206. For example, the platform server 218 may execute webserver software (e.g., Apache®, Microsoft IIS®) enabling the platform server 218 to execute functions the platform webserver 221, such as hosting webpages of the e-commerce platform 206 allowing the customer or the merchants to register with the e-commerce platform 206 and establish various configurations (e.g., triggering instructions, merchant online store configurations). As another example, the platform server 218 may cause the merchant's online store to interact with the customer devices 202 in accordance with the methods described herein, which may include updating product information for new or updated products in one or more databases.

The application 239 of the customer device 202 (or the platform server 218) may execute a spatially aware media engine that directly or indirectly generates AR overlays or other visual objects for media feed data presented to the user interface 234. The spatially aware media engine may generate instructions for the application 239 to generate the AR-enriched media data and the user interface 234. The customer device 202 may use these instructions to generate and display the user interface 234 to the customer. The platform server 218 or customer device 202 may perform various software processes for processing the image data for physical spaces and/or generating AR-enriched media feed data. Such software processes may include the various layers of the machine-learning architecture for object recognition or computer vision, such as object classification (e.g., object recognition engine) and spatial awareness within the coordinate system of the physical space (e.g., spatially aware media engine). As an example, for a particular physical space, the customer device 202 (or platform server 218) may recognize attributes of the physical space, such as the dimensions, colors, and barriers (e.g., walls, half-walls, doorways, windows) in the media data received from the customer device optical sensor 238. In some implementations, the spatially aware media engine analyzes the media data of a physical space to, for example, generate a 3D coordinate system for the physical space, recognizes or fetches attributes (e.g., people, objects, surfaces) in the physical space, maps the attributes to the coordinate system, pins or anchors attributes to the coordinate system, and applies the AR overlays or other virtual representations, among other potential functions.

In some embodiments, the platform server 218 may receive media data or other instructions or product information from the customer device 202, which the platform server 218 may process using various machine-learning architecture operations. The platform server 218 may perform various processes that ingest the media data and apply the layers of a machine-learning architecture defining a computer vision and/or object recognition engine to identify attributes of the physical space and recognize objects. The platform server 218 may generate and return the virtual representations, product information, or product comparison information. The platform server 218 may also generate or update database records containing the product information, as received from the customer device 202 or merchant server 204.

The platform database 208 may store and manage data records concerning various aspects of the e-commerce platform 206, including information about, for example, actors (e.g., merchants, customers, or platform administrators), electronic devices, merchant offerings (e.g., products, inventory, or services), product information, delivery methods, various metrics and statistics, machine-learning models, merchant pages hosting merchant stores, and other types of information related to the e-commerce platform 206 (e.g., usage and/or services). A computing device hosting the platform database 208 may include and execute database management system (DBMS 214) software, though a DBMS 214 is not required in every potential embodiment. The platform database 208 can be a single, integrated database structure or may be distributed into any number of database structures that are configured for some particular types of data needed by the e-commerce platform 206. For example, a first database could store customer credentials and be accessed for authentication purposes, and a second database could store raw or compiled machine-readable software code (e.g., HTML, JavaScript) for webpages such that the DB memory 210 is configured to store information for hosting webpages. The DB memory 210 of the platform database 208 may contain data records related to, for example, customer activity, and various information and metrics derived from web traffic involving customer accounts. The data may be accessible to the platform server 218. The platform server 218 may issue queries to the platform database 208 and data updates based upon, for example, successful or unsuccessful authentication sessions.

The platform database 208 may also include various libraries and data tables including detailed data needed to present products or objects via the merchant's online store and conduct transactions for the merchant's online store through the e-commerce platform 206. For instance, the platform server 218 may generate a data table associated with different products offered by different merchants and/or merchants' online stores.

The platform database 208, another non-transitory storage memory of the system 200, such as customer memory 232, merchant memory 240, or a merchant database (e.g., provider database 108) coupled to the merchant server 204, stores data records for products or objects. The data records include various product information, which includes various types of data and information, in various data formats. The product information may be pre-configured and updated automatically by the platform server 218 or merchant server 204 when new products are available in the e-commerce platform 206 or online merchant store. In some implementations, the platform database 208 or customer memory 232 stores product information for the products or objects previously-viewed by the customer device 202, such that the customer device 202 or other device continually or responsively captures and stores product information for objects that the customer comes across in the day. In some implementations, the customer device 202 or other device may continually capture imagery and generate media data for objects in the field of view of the optical sensor 238. The customer device 202 may also continually apply the object recognition engine on the image data for the plurality of current objects to identify the object, and, in some cases, extract attributes or other product information for the current object.

The merchant server 204 may be any server associated with a merchant hosting an online store. The merchant server 204 may be any computing device hosting a website (or any other electronic platform) accessible to customers (e.g., operating the customer device 202) via the network 228. The merchant server 204 may include a merchant processor 247 and non-transitory machine-readable storage (merchant memory 240) capable of executing various tasks described herein. The merchant processor 247 may include a computer-readable medium, such as a random access memory (RAM) coupled to the merchant processor 247. Non-limiting examples of the merchant processor 247 may include a microprocessor, an application-specific integrated circuit, and a field programmable object array, among others. Non-limiting examples of the merchant server 204 may include workstation computers, laptop computers, server computers, laptop computers, and the like. While the system 200 includes a single merchant server 204, in some embodiments the merchant server 204 may include a number of computing devices operating in a distributed computing environment.

In operation, the merchant server 204 may store product information for the various products offered on the merchant online store. As new or updated product information is added to the merchant memory 240, the merchant server 204 may upload the new or updated product information to the platform database 208.

### Example Processes

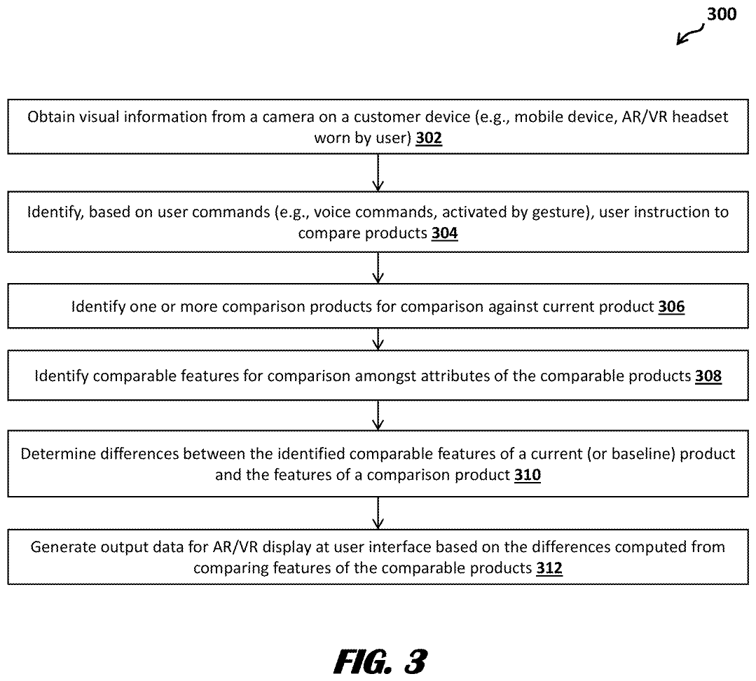

FIG. 3 shows operations of a method 300 for generating an AR/VR-enriched user interface for comparing a baseline object (sometimes referred to as a “current object”) against one or more comparison objects, according to an embodiment. Embodiments may include additional, fewer, or different operations than those described in the method 300. For case of description and understanding, a user device (e.g., customer device 202 of FIG. 2, user device 114 of FIG. 1) performs the software functions of the method 300, such as a laptop, smartphone, tablet, personal computer, or AR/VR headset device. However, embodiments may include any number of computing devices or processors that perform the various operations described in FIG. 3 and steps of the method 300. As an example, embodiments may include the customer device and an application server of a data-transaction platform service (e.g., platform server 218 of e-commerce platform 206, application server 102 of FIG. 1), such that the user device and the application server may each perform certain operations or steps of the method 300. As another example, embodiments may include an application server of the data-transaction provider platform that performs most or all of the functions and steps of the method 300, where the user device performs few, if any, operations or steps of the method 300. Moreover, in the method 300, a camera associated with (e.g., connected or integrated) the user device generates media data capturing imagery of objects, though embodiments may include any number of additional or alternative types of optical sensors (e.g., infrared, LIDAR).

In operation 302, the user device obtains media data with visual information from a camera of the user device (e.g., mobile device, AR/VR headset worn by user). The camera may generate media data in response to an instruction (as in step 304). Additionally or alternatively, the camera may continuously generate the media data and display the imagery in real time on the user interface of the user device.

In operation 304, the user device identifies the instruction to compare objects. In some cases, the user device identifies the instruction in response to user commands (e.g., voice commands, activated by gesture). The command includes instructions of any format and indicates the user's intent to compare two or more separate items. The user device may, for example, receive the user command when the user actuates an interactive component of the user interface or physical I/O component (e.g., physical button of the user device, mouse button) of the user device. In some cases, the user device automatically identifies (detects or infers) the user command based upon a user gesture, behavior, or speech, where the user device detects the user command based upon preconfigured triggering condition or instruction. As an example, the user device may be configured to trigger the instruction to compare objects automatically, in response to an object detection engine detecting one or more objects (e.g., the user device recognizes two comparable objects coming into view of the optical sensor). Additionally or alternatively, an object recognition engine executed by the user device trained to infer the user command from the user's gesture, behavior, or speech. For example, the object recognition engine or other aspect of the machine-learning architecture executed by the user device may be trained on the user's historical behavior (e.g., previous objects submitted for comparison; prior product purchases) to determine behavior patterns relative to objects, thereby training the object recognition engine to recognize the user's behavior. As an example, the user previously searched or compared oatmeal products, allowing the object recognition engine to continually recognize and generate alerts for oatmeal products or other products.

In some embodiments, the computing device may detect the user command based upon the preconfigured triggering condition prompting a comparison operation. Configuration settings of the software program of the user device may include the triggering condition that indicates the user instruction that automatically or responsively instructs the user device to perform certain actions, such as performing the comparison operation, generating media data, or identifying one or more comparison objects, among others. As an example, the user may hold up two different cartons of milk and speak the phrase “compare these.” In this example, a microphone of the user device captures audio data and a speech detection engine and/or natural language processing (NLP) engine executed by the user device detects the phrase “compare these.” The user device determines that the configuration settings include the triggering condition corresponding to the phrase “compare” or “compare these,” and then proceeds to perform further operations for the comparison operations. For instance, the user device determines that the phrase “these” or “compare these” prompts the user device to apply the object recognition engine on the two cartons of milk to identify comparative attributes or features for the products.

In some embodiments, the computing device may detect or infer the user command based on the user gestures or behaviors by applying an object recognition engine on the media data. The object recognition engine may be trained to recognize the user command and produce the triggering instruction according to any number of gestures or behaviors, using any number of inputs of an I/O device of the user device. As an example, the user device may identify the user command during a gesture or behavior in which the user lifts the user device upright (according to a gyroscope of the user device) and the camera captures imagery of an object on a shelf in the media data (according to the object recognition engine) for two or three seconds (according to the internal clock of the user device).

The user command may represent an instruction for the user device to invoke various processes, including the processes for the comparison functions. The user device may receive or identify various instruction parameters from the user command. The parameters of the instruction may indicate one or more objects to be compared or types of objects to be compared, among other types of parameters for comparing objects.

As in an earlier example, the user command prompts the user device to compare two cartons of milk. The user device identifies the instruction from the phrase “compare” or “compare these,” but the object recognition engine of the user device may further identify the cartons of milk as the instruction parameters. In this example, the user device determines that the instruction parameters indicate a first milk carton as the baseline object and a second milk carton as the comparison object.

As another example, the user command prompts the user device to compare a particular jar of peanut butter in the media data against a similar product. In this example, the object recognition engine identifies the product of the peanut butter, and the user device determines that the instruction parameters indicate the particular peanut butter product as the baseline product and that the user device needs to identify the comparison product(s).

In some cases, the user command prompts the user device to compare a space (e.g., car trunk, living room) against an object (e.g., duffle bag, furniture). The user instruction resulting from the user command includes parameters that indicate whether the space or the object is the baseline object. The user could say, for example, “will this bag fit in the trunk,” or “is the trunk large enough to fit this bag.” As an example, the user command prompts the user device to determine whether a car trunk in the camera's field of view could fit a particular bag. In this example, the user device determines that the car trunk is the baseline object in the parameters of the instruction and that the bag is the comparison object. A spatially aware engine maps a coordinate plane for the car trunk according to dimensions of the car trunk. The user device identifies or determines object information for the bag as the comparison object, including determining the dimensions of the bag.

In operation 306, the user device identifies one or more comparison objects for comparison against the baseline object. In some embodiments, the user device executes a selection engine for determining the one or more comparison objects, where the selection engine may be distinct from, or a component of, a comparison engine or object recognition engine. The user instruction need not expressly indicate the two or more objects for comparison. As an example, the user device may receive the user instruction where only one milk carton product is present in the field of view of the camera. The user instruction may, for example, indicate the baseline product and instruct the user device to identify the comparison product, or the user may instruct to identify additional comparison products.

In operation, after the object recognition engine of the user device identifies the baseline object, the user device queries a local memory or remote memory (e.g., application database, merchant database, third-party webserver of grocery store or search engine) for object data of the baseline object. The object data includes various types of image data, attribute data, and feature data about the particular object, which may be in any number of data formats. If the user instruction indicates the comparison objects, then the object recognition engine identifies the comparison object, and the user device retrieves the object data for the comparison object from the local memory or remote memory. Information for the comparison object may be based upon previously-viewed objects and may be stored in the local or remote memory.

As an example, a user holding a carton of milk from Brand_A may provide a user command as a spoken question: “How does this [Carton_A of Brand_A] compare to that [user momentarily gestures (e.g., looks at, points at, otherwise indicates Carton_B of Brand_B)].” In this example, the object recognition engine recognizes Carton_A and determines the baseline object as a milk product of Brand_A and the user device retrieves the product information about the baseline object from the local memory of the user device. Similarly, the object recognition engine recognizes Carton_B and determines the comparison object as a milk product of Brand_B and the user device retrieves the product information about the comparison object from the local memory of the user device.

In some circumstances, the user device determines the comparison object in response to a user instruction that does indicate the comparison object. For instance, the user command does not expressly indicate the particular comparison object (e.g., the instruction is based on the user command: “compare against similar products”), or the user device camera feed may not include imagery of the comparison object when the user device receives the user command or the object not recognizable from the camera feed. Continuing with the earlier example, if Carton_B is not recognizable or not detectable from the camera feed, then the object recognition engine or other software function of the user device may receive or recognize a specific brand name (e.g., Brand_B), another identifier, or another feature of the milk carton. The object recognition engine or the selection engine may query the local memory or remote memory to resolve and identify the particular Carton_B and to retrieve the related product information using the specific brand name (e.g., Brand_B), another identifier, or another feature of the milk carton, as inputted by the user or recognized by the object rejection engine.

In some implementations, the selection engine executed by the user device includes pre-configured mappings between the particular baseline object to a listing of one or more comparison objects or a category of similar objects. The category of similar objects may indicate the listing of one or more comparison objects or may indicate various features that the user device references to identify the comparison object. The user device identifies or extracts features representing attributes or characteristics of the baseline object, which the user may provide or the user device automatically extracts using the media data. The user device then uses the mappings to identify the comparison object by cross-referencing the objects, features, or categories extracted for the baseline object against the objects, features, or categories for the comparison object in the mappings.

Additionally or alternatively, the selection engine includes a classifier layer of a machine-learning architecture trained to determine or infer the comparison object or the category of similar objects based upon one or more features of the baseline object, extracted using the media data or the user inputs.

Optionally, in operation 308, the user device identifies comparable features for comparison amongst attributes of the comparable objects. In some implementations, the user device continuously monitors and interprets interactions (e.g., eye-tracking staring at portion of object, voice commands, hand gestures) between the user and the user device or interactions between the user and the baseline object in the camera feed. The user device may interpret these interactions as components of the user command and/or the instruction parameters. The user device may determine particular comparison features of the baseline object and/or the comparison object(s) based upon these user interactions. The user device may identify certain object information corresponding to the comparison feature of the comparison object from inputs of the camera feed (e.g., in the example of the user holding two cartons of milk) or by querying object information from the local memory or remote storage.

As an example, as the user looks at a first bike, the camera feed includes imagery capturing the user's eye-line. The software of the user device may track the user's eyes, which may shift to gaze upon different parts of the first bike. The user device may dynamically identify attributes or features of the part of the first bike, and query or filter object information about the part of the first bike using the object information in the local memory or the remote memory. The user device may eventually present the tailored object information on the user interface (as in step 312). In some cases, the tailored object information includes image data that the user device references to generate an AR/VR overlay, presented over the corresponding part of a second bike.

As another example, the user looks at a portion of the baseline object selected from a shelf, such as a nutrition label of a jar of peanut butter. The user device determines that the user is looking at the portion of the jar, and recognizes the nutrition label in the user's eye-line. After the user device determines the comparison object, the user device may query and retrieve a preconfigured nutrition label image or nutrition data in the object data of the comparison object. Additionally or alternatively, the user device determines or recognizes a portion of the comparison product (e.g., jar of a different peanut butter) having similar visual features as the nutrition label of the baseline product. The user device may generate the comparative user interface displaying the nutrition labels. In some cases, the user device may apply an optical character recognition operation to the image data to recognize and extract object information from the visual features of the object. In such cases, the computing device may compare the object information as structured data or text, in addition or as an alternative to generating comparative user interfaces (as in step 312) using simple image data.

As another example, the user looks at a portion of the baseline product selected from a shelf, such as a protein content entry line on the nutrition label. The user device determines that the user is looking at the portion of the jar, and recognizes the nutrition label in the user's eye-line. While holding the comparison product, the user device recognizes the nutrition label of the comparison product in the camera view. In some cases, the user device recognizes the corresponding features of the nutrition label (e.g., the protein content entry line) of the comparison product. The user device may generate (as in step 312) a highlighting-effect or AR overly on the user interface such that the user interface visually highlights the protein row of each nutrition label in the real-time image presented on the user interface.

Optionally, in operation 310, the user device determines (or computes) differences between the identified comparable features of the current baseline object and the features of the comparison object. It should be appreciated that, in some circumstances, the user device may determine that the types or amount of “differences” may be “null” or “none,” thereby determining that the one or more features do not differ (e.g. zero difference or otherwise not substantially difference). In some cases, the user device retrieves object information for the baseline object and/or the comparison object. For instance, the object information of the baseline object and/or the comparison object includes image data as a virtual representation of each particular object, which the user device references to generate one or more AR overlays on the real time imagery displayed in the user interface or as one or more VR objects to present in a VR-based user interface. In some cases, the user device extracts or retrieves various types of data or text in the object information or the media data for the baseline object and for the comparison object. Using the comparison results, the user device may generate certain types of output data to present for the user interface, such as an AR overlay based on the comparison results and/or the object information.

In operation 312, the user device generates the output data for the user interface comparing the objects. As mentioned, the user device may retrieve object information for the baseline object and/or the comparison object that the user device may reference to generate aspects of the AR-enriched user interface or of the VR-based user interface. For instance, the object information of the baseline object and/or the comparison object includes image data as the virtual representation of each particular object, which the user device references to generate one or more AR overlays on the real time imagery displayed in the user interface or as one or more VR objects to present in the VR-based user interface.

As an example, the camera captures imagery of a car's open trunk as the baseline object. The spatially aware engine of the user device identifies the physical attributes of the trunks to generate a coordinate plane mapping the contours of the trunk. The computing device may generate a virtual “wire mesh” representing the contours of the car trunk as an AR overlay on the real time media data of the car trunk presented in the user interface. The user instruction may indicate the comparison object, such as another car's trunk or a duffle bag, which the user device identifies or recognizes. The user device may recognize the object information for the comparison object, such as physical attributes and an image object representing the comparison object. Additionally or alternatively, the user device may query the local memory or remote memory for the object information related to the comparison object. After recognizing or retrieving the object information for the comparison object, the user device updates the user interface to include the comparison object as an AR overlay situated in the user interface over the real time image displaying of the baseline car trunk. For instance, the AR overlay may display a virtual image object representing the second car trunk (or a wireframe mesh of the second car trunk) over the real time image displaying the baseline car trunk in the user interface. Or, the AR overlay may display the duffle bag image object situated over the real time image displaying the car trunk in the user interface.

In some implementations, the output data may be based on the differences between the object and the comparable object. The AR overlay may, for example, conceal, omit, or otherwise obfuscate objects that do not have a threshold amount of differences, such that the graphical user interface only displays objects that have the threshold level of difference. In some configurations, the user device may be configured to selectively display objects to save space, such that the graphical user interface displays objects depending on space available (e.g., computed based on incoming image data).

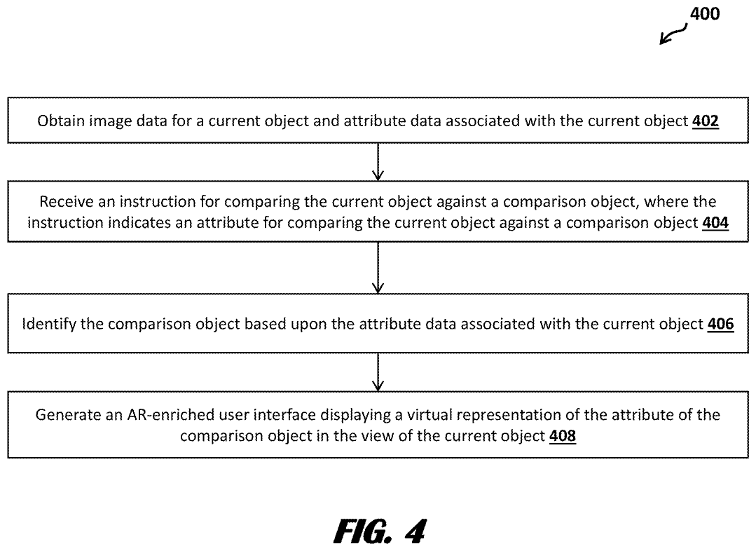

FIG. 4 shows operations of a method 400 for generating an AR/VR-enriched user interface for comparing a baseline object (sometimes referred to as a “current object”) against one or more comparison objects, according to an embodiment. Embodiments may include additional, fewer, or different operations than those described in the method 400. For ease of description and understanding, a processor is associated with an AR device, where the processor may be connected (by wire connection or close proximity wireless connection) to the AR device or may be integrated as a component of the AR device. The processor and/or the AR device may include a computing device (e.g., user device 114, customer device 202, application server 102, platform server 218) that performs various software functions of the method 400, where the processor may be a component of a computing device, such as a laptop, smartphone, tablet, personal computer, or AR/VR headset device. Similarly, the AR device may be a computing device such as a laptop, smartphone, tablet, personal computer, or AR/VR headset device. Embodiments, however, may include any number of processors, AR devices, or other computing devices that perform the various operations described in FIG. 4 and steps of the method 400. As an example, embodiments may include a user device (e.g., customer device 202) as the AR device comprising the processor, and an application server of a data-transaction platform service (e.g., platform server 218 of e-commerce platform 206), such that the user device and the application server may each perform certain operations or steps of the method 400.

Moreover, in the method 400, a camera associated with (e.g., connected to or integrated into) the processor of the AR device generates media data capturing imagery of objects, though embodiments may include any number of additional or alternative types of optical sensors (e.g., infrared, LIDAR).

In operation 402, the processor obtains the media data, including image data, for a current baseline object and attribute data associated with the baseline object. The processor may receive the attribute data from the user input or instruction, from a local memory coupled to the processor, from a remote memory accessible to the processor via one or more networks, or by recognizing the one or more attributes of the baseline object by executing an object recognition engine and/or a spatially aware engine. The attribute data includes, for example, physical attributes (e.g., dimensions, colors), types of objects, or various types of information or text.

In operation 404, the processor receives an instruction prompting a comparison operation and indicating an attribute of the baseline object. In some cases, the processor may reference the attribute to recognize the baseline object and/or to identify the one or more comparison objects for the comparison. For instance, the attribute may indicate the type of object of the baseline object or the type of object for the comparison object. In some cases, the processor may reference the attribute for comparing the baseline object against the corresponding attribute of the comparison attribute. For instance, the attribute may be a color or physical dimensions for comparing the baseline object against the comparison object.

The processor may receive the instruction as a user input when the user actuates a physical component (e.g., physical button) of the computing device or interactive component of the user interface (e.g., user interface button element). In some cases, the instruction comprises a user gesture indicating the current object for the comparison against the comparison object. Additionally or alternatively, the processor receives the instruction in response to a trigger condition based user gesture, behavior, or other type of input that the processor recognizes in various types of input data, such as media data (e.g., imagery of a camera, audio of a microphone) or orientation data of a gyroscope, among other.

In some implementations, the processor applies an object recognition engine and/or character recognition engine on an image of the current object. The processor then identifies a text attribute of the current object in the image data for the current object. Additionally or alternatively, identifies one or more types of attributes by applying the object recognition engine on the image data of the current object. The object recognition engine may extract the attributes as attribute data as object data or product information of the current object.

In operation 406, the processor identifies the comparison object based upon the attribute data associated with the current object. The processor may identify one or more attributes in the attribute data or other object information of the current object. Using the attributes of the current object, the processor may determine a comparison object having the one or more attributes in the attribute data of the comparison object.

In some embodiments, the processor applies the object recognition engine of a machine-learning architecture on the image data of the current object to extract the one or more attributes of the attribute data identified or extracted for the current object. The processor then applies a selection engine (which may be a component of, or distinct from, a comparison engine or objection recognition engine) of a machine-learning architecture on the one or more attributes of the current object, including the attribute indicated by the instruction. The selection engine may extract a first feature vector representing the one or more attributes in the attribute data for the current object and determine a similarity score for the current object compared to a comparison object. The processor determines the similarity score based on a level of similarity (e.g., cosine distance) from the first feature vector for the current object and a second feature vector for the comparison object. The processor may extract the second feature vector from an image of the comparison object or from the object information of the comparison object. Alternatively, the processor may retrieve the second feature vector from the database. The selection engine identifies another object as the comparison object if the similarity score generated for the comparison object satisfies a threshold score.

In some embodiments, a database of objects is stored in local memory or remote memory accessible to the processor. The database includes one or more preconfigured mappings that indicate comparison objects or categories of comparison objects having some or all of the one or more attributes of the current object. The selection engine may identify a category of comparison objects or the comparison object having the attribute in the instruction (and any other one or more attributes) mapped to the one or more attributes of the current object.

In operation 408, the processor generates an AR-enriched graphical user interface containing AR components for display at the AR device. The AR graphical user interface displays a virtual visual representation of the attribute of the comparison object in the view of the current object. The processor generates the AR-enriched graphical user interface that displays a virtual representation of the attribute of the comparison object with in the view of (e.g., overlay, next to) the current object in the graphical user interface.

The virtual representation may include various types of object information, such as the attributes or image data for the current object and comparison object. For example, the virtual representation may include virtual representations as the images of one or more objects. As another example, the virtual representation may include an image of one or more objects or images of a portion of the one or more objects, where the processor may extract an image of an object from the media data generated by the camera or may retrieve an image of an object from a database of objects, hosted in the local memory or in a remote memory. In operation, the processor may generate the AR graphical user interface by generating an AR overlay for the virtual representation based upon the particular attribute indicated by the instruction. For instance, the attribute may include certain types of object information, such as nutrition information or physical attributes, and may be presented in various types of data formats, such as image data displaying nutrition panels on the packaging of the objects or text-based data of the nutrition information of the objects. The processor generates the AR overlay as the virtual representation for the particular attribute.

In some embodiments, the processor (or AR device) dynamically generates and updates the AR overlays based upon multiple attributes indicated by the instruction or later updating instructions in which the user refines or changes the attributes for comparison. In operation, the processor generates the initial AR overlay as the virtual representation for the particular initial attribute of interest. At a later time, the processor obtains (e.g., receives, detects) a follow-up, second user command providing an updating instruction to the processor. This second instruction indicates a second attribute for the processor and prompts the processor to update the AR graphical user interface. In operation, the processor generates a second AR overlay for the virtual representation in the AR graphical user interface based on the second attribute. The user may indicate that the attribute for comparison changes for any number of objects, such that the processor may change the attribute and AR overlay for only some of the objects being compared. The processor and AR device may then update the AR graphical user interface to display a second virtual representation containing the second AR overlay for the second attribute of one or more objects being compared.

The AR graphical user interface need not display the AR overlay for the comparison object's attribute over (on top of) the corresponding attribute of the current object. In some cases, the processor or the AR device generates and displays the AR overlay of the virtual representation of the particular attribute (in the instruction) of the comparison object, where the AR overlay is displayed within a visual proximity, in the AR graphical user interface, to the particular attribute (in the instruction) of the current object. In this way, the user may visually compare the respective attributes in the AR graphical user interface being visually positioned, for example, side-by-side or intersecting (e.g., partially covering, over top of).

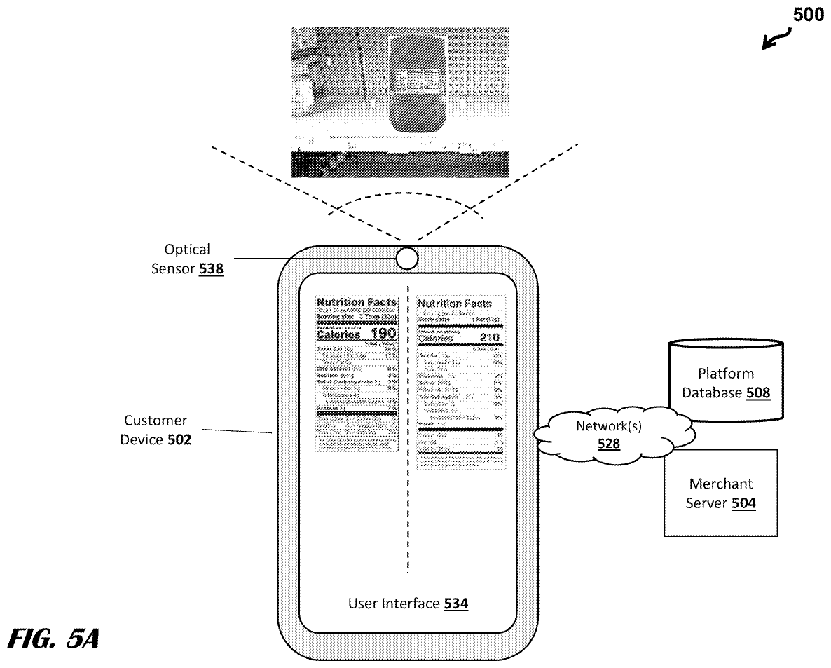

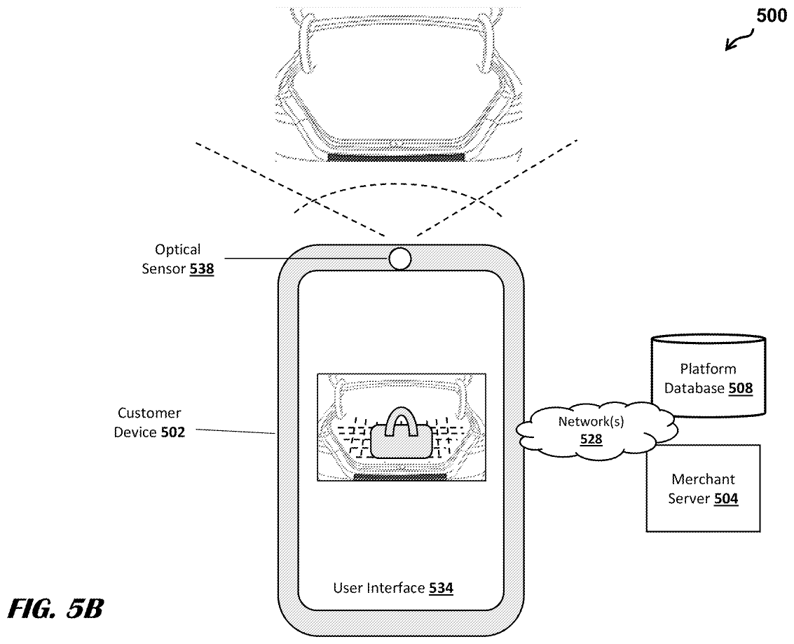

Examples of comparisons using the above-described functionality are shown in FIGS. 5A-5B, which show components of a system 500 that generates AR/VR-enriched user interfaces 534 for comparing products. The system 500 includes a customer device 502, platform database 508, and merchant server 504, which communicate with one another via one or more networks 528. The customer device 502 comprises an optical sensor 538 (e.g., camera) that captures a product in a field of view of the optical sensor 538 and generates media data containing imagery of products or product information.

In FIG. 5A, the field of view of the optical sensor 538 captures imagery of a baseline product, which includes a jar of peanut butter on a shelf at a brick-and-mortar store, and the optical sensor 538 generates media data converted from the imagery captured by the optical sensor 538. The customer device 502 applies an object rejection engine on the media data that recognizes the particular baseline product (e.g., peanut butter brand and specific product) according to visual features and/or user inputs indicating the baseline product. In some cases, the customer device retrieves product information for the baseline product, including an image of nutrition facts or other types of data format containing the nutrition facts for the baseline product. In some cases, the customer device recognizes and extracts the product information from the media data, including the image of the nutrition facts panel or other types of data format representing the nutrition facts.

The customer device 502 executes software programming that determines a comparison products (e.g., another brand of peanut butter). In some embodiments, the customer device 502 or other device of the system 500 (e.g., platform server) executes a selection engine that identifies and determines the comparison products for comparison against the baseline product. The customer device 502 identifies the attributes of the baseline product from the imagery data and determines which products are comparable. In some cases, the customer device 502 recognizes the baseline product and one or more attributes or features of the baseline product. The selection engine then queries the local memory or remote memory (e.g., platform database 508, merchant server 504) for the comparison object having a comparable attributes, such as the type or category of the baseline product and of the comparison product. In some cases, the customer device 502 executes a classifier function of a machine-learning architecture that determines the comparison product based upon various features extracted using the attributes recognized in the baseline product.

The customer device 502 then generates or updates the user interface 534 to present image data of portions of the baseline product and the comparison products, such as images of the nutrition facts panels. In some cases, the user instruction or parameters indicate that the user is focused on comparing certain attributes, such as the protein content row of the nutrition panel. In such cases, the customer device 502 generates an AR overlay on the image data for display in the graphical user interface of the user device or external display device (e.g., VR device 114c), circling or highlighting the protein content rows. Additionally or alternatively, the customer device 502 generates or updates the user interface 534 to present the nutrition facts in another data format (e.g., text).

In FIG. 5B, the field of view of the optical sensor 538 captures imagery of an open car trunk as the baseline product, and the optical sensor 538 generates media data converted from the captured imagery. The customer device 502 applies an object rejection engine and spatially aware engine on the media data that recognizes physical attributes (e.g., contours, dimensions) of the baseline product according to visual features and/or user inputs indicating the baseline product. In some cases, the customer device retrieves product information for the baseline product, including various types of data indicating the attributes of the open trunk. In some cases, the customer device recognizes and extracts the product information from the media data, including the attributes of the open trunk. The spatially aware engine may generate virtual wire mesh representing the physical contours of the trunk.

The customer device 502 receives an instruction parameter indicating a comparison product as a duffle bag that the user wants to know whether the duffle bag will fit into the open trunk. The customer device 502 may retrieve the product information of the comparison object, including an image data (e.g., virtual object image) representing the duffle bag and the dimensions of the duffle bag. The customer device 502 may retrieve the product information by querying a local memory, the platform database 508, or a merchant server 504. The customer device 502 may generate an AR overlay based on the image data for the comparison object.

The customer device 502 then generates or updates the media feed presented on the user interface 534 using the AR overlay. The user interface 534 then displays the image data of the comparison object (e.g., virtual object representing the duffle bag) situated in the real time camera feed displaying the baseline product (car trunk).

### Example E-Commerce Platform

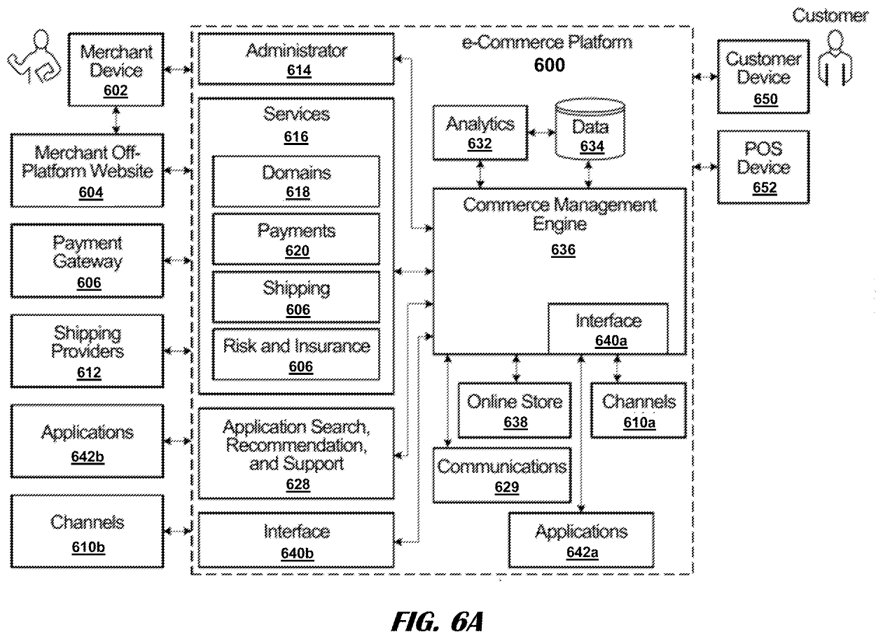

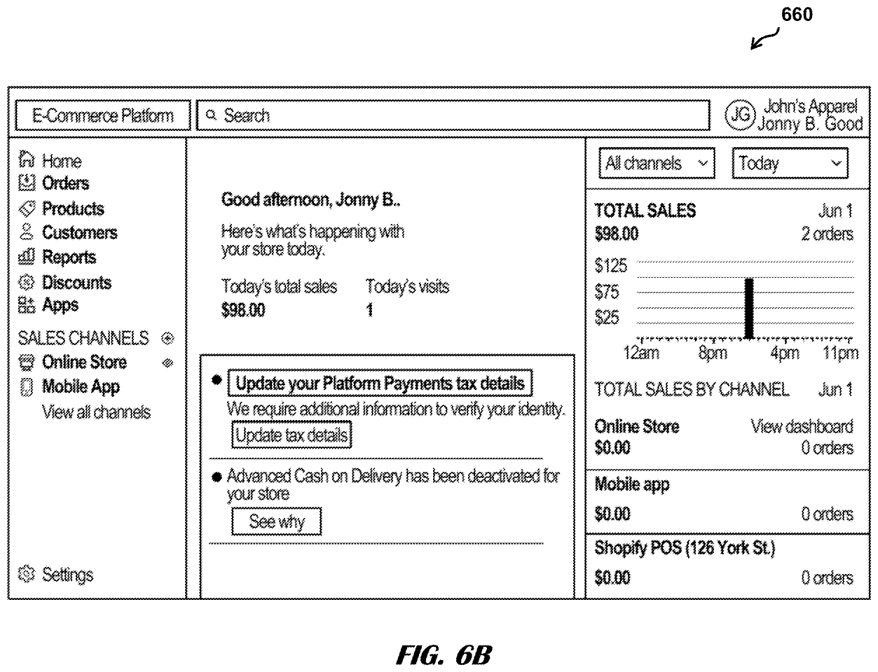

As shown FIGS. 6A-6B, in some embodiments, the systems and methods disclosed herein may be implemented or performed on or in association with a computing platform, such as an e-commerce platform 600. Therefore, an example of a commerce platform will be described by way of introduction. However, it should be understood that the e-commerce platform 600 is only one possible example of an online platform and is not intended to be limiting. Another example in the context of a computing device is also described. In that manner, the present disclosure may be implemented in other contexts, and is not necessarily limited to implementation in an e-commerce platform 600 or a user device.

FIG. 6A illustrates components of a system hosting or interacting with an e-commerce platform 600, according to one embodiment. The e-commerce platform 600 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 600 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 600 for potential use in marketing and selling products, and the like), a service provider user (e.g., a shipping provider 612, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 600 may provide a centralized system for providing merchants with online resources and facilities for managing their business. The facilities described herein may be deployed in part or in whole through a machine that executes computer software, modules, program codes, and/or instructions on one or more processors, which may be part of or external to the e-commerce platform 600. Merchants may utilize the e-commerce platform 600 for managing commerce with customers, such as by implementing an e-commerce experience with customers through an online store 638, through channels 610a-610b, through POS devices 652 in physical locations (e.g., a physical storefront or other location such as through a kiosk, terminal, reader, printer, 3D printer, and the like), by managing their business through the e-commerce platform 600, and by interacting with customers through a communications facility 629 of the e-commerce platform 600, or any combination thereof. A merchant may utilize the e-commerce platform 600 as a sole commerce presence with customers, or in conjunction with other merchant commerce facilities, such as through a physical store (e.g., ‘brick-and-mortar’ retail stores), a merchant off-platform website 604 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 652 in a physical store of a merchant are linked into the e-commerce platform 600, where a merchant off-platform website 604 is tied into the e-commerce platform 600, such as through ‘buy buttons’ that link content from the merchant off platform website 604 to the online store 638, and the like.

The online store 638 may represent a multitenant facility comprising a plurality of virtual storefronts. In embodiments, merchants may manage one or more storefronts in the online store 638, such as through a merchant device 602 (e.g., computer, laptop computer, mobile computing device, and the like), and offer products to customers through a number of different channels 610a-610b (e.g., an online store 638; a physical storefront through a POS device 652; electronic marketplace, through an electronic buy button integrated into a website or social media channel such as on a social network, social media page, social media messaging system; and the like). A merchant may sell across channels 610a-610b and then manage their sales through the e-commerce platform 600, where channels 610a may be provided internal to the e-commerce platform 600 or from outside the e-commerce channel 610b. A merchant may sell in their physical retail store, at pop ups, through wholesale, over the phone, and the like, and then manage their sales through the e-commerce platform 600. A merchant may employ all or any combination of these, such as maintaining a business through a physical storefront utilizing POS devices 652, maintaining a virtual storefront through the online store 638, and utilizing a communication facility 629 to leverage customer interactions and analytics 632 to improve the probability of sales. Throughout this disclosure, the terms “online store 638” and “storefront” may be used synonymously to refer to a merchant's online e-commerce offering presence through the e-commerce platform 600, where an online store 638 may refer to the multitenant collection of storefronts supported by the e-commerce platform 600 (e.g., for a plurality of merchants) or to an individual merchant's storefront (e.g., a merchant's online store).

In some embodiments, a customer may interact through a customer device 650 (e.g., computer, laptop computer, mobile computing device, and the like), a POS device 652 (e.g., retail device, a kiosk, an automated checkout system, and the like), or any other commerce interface device known in the art. The e-commerce platform 600 may enable merchants to reach customers through the online store 638, through POS devices 652 in physical locations (e.g., a merchant's storefront or elsewhere), to promote commerce with customers through dialog via electronic communication facility 629, and the like, providing a system for reaching customers and facilitating merchant services for the real or virtual pathways available for reaching and interacting with customers.

In some embodiments, and as described further herein, the e-commerce platform 600 may be implemented through a processing facility including a processor and a memory, the processing facility storing a set of instructions that, when executed, cause the e-commerce platform 600 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 600, merchant devices 602, payment gateways 606, application developers, channels 610a-610b, shipping providers 612, customer devices 650, point of sale devices 652, and the like. The e-commerce platform 600 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 600 may be implemented to operate on various platforms and operating systems, such as IOS, Android, on the web, and the like (e.g., the administrator 614 being implemented in multiple instances for a given online store for iOS, Android, and for the web, each with similar functionality).

In some embodiments, the online store 638 may be served to a customer device 650 through a webpage provided by a server of the e-commerce platform 600. The server may receive a request for the webpage from a browser or other application installed on the customer device 650, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 650 and then the template language is replaced by data from the online store 638, such as when a theme is installed. The template and themes may consider tags, objects, and filters. The client device web browser (or other application) then renders the page accordingly.

In some embodiments, online stores 638 may be served by the e-commerce platform 600 to customers, where customers can browse and purchase the various products available (e.g., add them to a cart, purchase immediately through a buy-button, and the like). Online stores 638 may be served to customers in a transparent fashion without customers necessarily being aware that it is being provided through the e-commerce platform 600 (rather than directly from the merchant). Merchants may use a merchant configurable domain name, a customizable HTML theme, and the like, to customize their online store 638. Merchants may customize the look and feel of their website through a theme system, such as where merchants can select and change the look and feel of their online store 638 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 638, such as through blogs, articles, and the like, as well as configure navigation menus. Merchants may upload images (e.g., for products), video, content, data, and the like to the e-commerce platform 600, such as for storage by the system (e.g., as data 634). In some embodiments, the e-commerce platform 600 may provide functions for resizing images, associating an image with a product, adding and associating text with an image, adding an image for a new product variant, protecting images, and the like.

As described herein, the e-commerce platform 600 may provide merchants with transactional facilities for products through a number of different channels 610a-610b, including the online store 638, over the telephone, as well as through physical POS devices 652 as described herein. The e-commerce platform 600 may include business support services 616, an administrator 614, and the like associated with running an on-line business, such as providing a domain service 618 associated with their online store, payment services 620 for facilitating transactions with a customer, shipping services 622 for providing customer shipping options for purchased products, risk and insurance services 624 associated with product protection and liability, merchant billing, and the like. Services 616 may be provided via the e-commerce platform 600 or in association with external facilities, such as through a payment gateway 606 for payment processing, shipping providers 612 for expediting the shipment of products, and the like.

In some embodiments, the e-commerce platform 600 may provide for integrated shipping services 622 (e.g., through an e-commerce platform shipping facility or through a third-party shipping carrier), such as providing merchants with real-time updates, tracking, automatic rate calculation, bulk order preparation, label printing, and the like.

FIG. 6B depicts a non-limiting embodiment for a home page 660 of an administrator 614, which may show information about daily tasks, a store's recent activity, and the next steps a merchant can take to build their business. In some embodiments, a merchant may log in to administrator 614 via a merchant device 602 such as from a desktop computer or mobile device, and manage aspects of their online store 638, such as viewing the online store's 138 recent activity, updating the online store's 638 catalog, managing orders, recent visits activity, total orders activity, and the like. In some embodiments, the merchant may be able to access the different sections of administrator 614 by using the sidebar, such as shown on FIG. 6B. Sections of the administrator 614 may include various interfaces for accessing and managing core aspects of a merchant's business, including orders, products, customers, available reports, and discounts. The administrator 614 may also include interfaces for managing sales channels for a store including the online store, mobile application(s) made available to customers for accessing the store (Mobile App), POS devices, and/or a buy button. The administrator 614 may also include interfaces for managing applications (Apps) installed on the merchant's account; settings applied to a merchant's online store 638 and account. A merchant may use a search bar to find products, pages, or other information. Depending on the device 602 or software application the merchant is using, they may be enabled for different functionality through the administrator 614. For instance, if a merchant logs in to the administrator 614 from a browser, they may be able to manage all aspects of their online store 638. If the merchant logs in from their mobile device (e.g., via a mobile application), they may be able to view all or a subset of the aspects of their online store 638, such as viewing the online store's 638 recent activity, updating the online store's 638 catalog, managing orders, and the like.

More detailed information about commerce and visitors to a merchant's online store 638 may be viewed through acquisition reports or metrics, such as displaying a sales summary for the merchant's overall business, specific sales and engagement data for active sales channels, and the like. Reports may include acquisition reports, behavior reports, customer reports, finance reports, marketing reports, sales reports, custom reports, and the like. The merchant may be able to view sales data for different channels 610a-610b from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 638, such as based on account status, growth, recent customer activity, and the like. Notifications may be provided to assist a merchant with navigating through a process, such as capturing a payment, marking an order as fulfilled, archiving an order that is complete, and the like.

The e-commerce platform 600 may provide for a communications facility 629 and associated merchant interface for providing electronic communications and marketing, such as utilizing an electronic messaging aggregation facility for collecting and analyzing communication interactions between merchants, customers, merchant devices 602, customer devices 650, POS devices 652, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 629 analyzes the interaction and provides analysis to the merchant on how to improve the probability for a sale.

The e-commerce platform 600 may provide a financial facility 620 for secure financial transactions with customers, such as through a secure card server environment. The e-commerce platform 600 may store credit card information, such as in payment card industry data (PCI) environments (e.g., a card server), to reconcile financials, bill merchants, perform automated clearing house (ACH) transfers between an e-commerce platform 600 financial institution account and a merchant's bank account (e.g., when using capital), and the like. These systems may have Sarbanes-Oxley Act (SOX) compliance and a high level of diligence required in their development and operation. The financial facility 620 may also provide merchants with financial support, such as through the lending of capital (e.g., lending funds, cash advances, and the like) and provision of insurance. In addition, the e-commerce platform 600 may provide for a set of marketing and partner services and control the relationship between the e-commerce platform 600 and partners. They also may connect and onboard new merchants with the e-commerce platform 600. These services may enable merchant growth by making it easier for merchants to work across the e-commerce platform 600. Through these services, merchants may be provided help facilities via the e-commerce platform 600.

In some embodiments, online store 638 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 600. In some embodiments, the e-commerce platform 600 may store this data in a data facility 634. The transactional data may be processed to produce analytics 632, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 600 may store information about business and merchant transactions, and the data facility 634 may have many ways of enhancing, contributing, refining, and extracting data, where over time the collected data may enable improvements to aspects of the e-commerce platform 600.

Referring again to FIG. 6A, in some embodiments the e-commerce platform 600 may be configured with a commerce management engine 636 for content management, task automation and data management to enable support and services to the plurality of online stores 638 (e.g., related to products, inventory, customers, orders, collaboration, suppliers, reports, financials, risk and fraud, and the like), but be extensible through applications 642a-642b that enable greater flexibility and custom processes required for accommodating an ever-growing variety of merchant online stores, POS devices, products, and services, where applications 642a may be provided internal to the e-commerce platform 600 or applications 642b from outside the e-commerce platform 600. In some embodiments, an application 642a may be provided by the same party providing the platform 600 or by a different party. In some embodiments, an application 642b may be provided by the same party providing the platform 600 or by a different party. The commerce management engine 636 may be configured for flexibility and scalability through portioning (e.g., sharding) of functions and data, such as by customer identifier, order identifier, online store identifier, and the like. The commerce management engine 636 may accommodate store-specific business logic and in some embodiments, may incorporate the administrator 614 and/or the online store 638.

The commerce management engine 636 includes base or “core” functions of the e-commerce platform 600, and as such, as described herein, not all functions supporting online stores 638 may be appropriate for inclusion. For instance, functions for inclusion into the commerce management engine 636 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 638 (e.g., functions that can be re-used/modified across core functions), limited to the context of a single online store 638 at a time (e.g., implementing an online store ‘isolation principle’, where code should not be able to interact with multiple online stores 638 at a time, ensuring that online stores 638 cannot access each other's data), provide a transactional workload, and the like. Maintaining control of what functions are implemented may enable the commerce management engine 636 to remain responsive, as many required features are either served directly by the commerce management engine 636 or enabled through an interface 640a-640b, such as by its extension through an application programming interface (API) connection to applications 642a-642b and channels 610a-610b, where interfaces 640A may be provided to applications 642a and/or channels 610a inside the e-commerce platform 600 or through interfaces 640b provided to applications 642b and/or channels 610b outside the e-commerce platform 600. Generally, the platform 600 may include interfaces 640a-640b (which may be extensions, connectors, APIs, and the like) which facilitate connections to and communications with other platforms, systems, software, data sources, code and the like. Such interfaces 640a-640b may be an interface 640a of the commerce management engine 636 or an interface 640b of the platform 600 more generally. If care is not given to restricting functionality in the commerce management engine 636, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 636 may be configured to maintain responsiveness, such as through configuration that utilizes timeouts, queues, back-pressure to prevent degradation, and the like.

Although isolating online store data is important to maintaining data privacy between online stores 638 and merchants, there may be reasons for collecting and using cross-store data, such as for example, with an order risk assessment system or a platform payment facility, both of which require information from multiple online stores 638 to perform well. In some embodiments, rather than violating the isolation principle, it may be preferred to move these components out of the commerce management engine 636 and into their own infrastructure within the e-commerce platform 600.

In some embodiments, the e-commerce platform 600 may provide for a platform payment facility 620, which is another example of a component that utilizes data from the commerce management engine 636 but may be located outside so as to not violate the isolation principle. The platform payment facility 620 may allow customers interacting with online stores 638 to have their payment information stored safely by the commerce management engine 636 such that they only have to enter it once. When a customer visits a different online store 638, even if the customer has never been there before, the platform payment facility 620 may recall their information to enable a more rapid and correct check out. This may provide a cross-platform network effect, where the e-commerce platform 600 becomes more useful to its merchants as more merchants join, such as because there are more customers who checkout more often because of the case of use with respect to customer purchases. To maximize the effect of this network, payment information for a given customer may be retrievable from an online store's checkout, allowing information to be made available globally across online stores 638. It would be difficult and error prone for each online store 638 to be able to connect to any other online store 638 to retrieve the payment information stored there. As a result, the platform payment facility may be implemented external to the commerce management engine 636.

For those functions that are not included within the commerce management engine 636, applications 642a-642b provide a way to add features to the e-commerce platform 600. Applications 642a-642b may be able to access and modify data on a merchant's online store 638, perform tasks through the administrator 614, create new flows for a merchant through a user interface (e.g., that is surfaced through extensions/API), and the like. Merchants may be enabled to discover and install applications 642a-642b through application search, recommendations, and support 628. In some embodiments, core products, core extension points, applications, and the administrator 614 may be developed to work together. For instance, application extension points may be built inside the administrator 614 so that core features may be extended by way of applications, which may deliver functionality to a merchant through the extension.

In some embodiments, applications 642a-642b may deliver functionality to a merchant through the interface 640a-640b, such as where an application 642a-642b is able to surface transaction data to a merchant (e.g., App: “Engine, surface my app data in mobile and web admin using the embedded app SDK”), and/or where the commerce management engine 636 is able to ask the application to perform work on demand (Engine: “App, give me a local tax calculation for this checkout”).

Applications 642a-642b may support online stores 638 and channels 610a-610b, provide for merchant support, integrate with other services, and the like. Where the commerce management engine 636 may provide the foundation of services to the online store 638, the applications 642a-642b may provide a way for merchants to satisfy specific and sometimes unique needs. Different merchants will have different needs, and so may benefit from different applications 642a-642b. Applications 642a-642b may be better discovered through the c-commerce platform 600 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 642a-642b may be connected to the commerce management engine 636 through an interface 640a-640b, such as utilizing APIs to expose the functionality and data available through and within the commerce management engine 636 to the functionality of applications (e.g., through REST, GraphQL, and the like). For instance, the e-commerce platform 600 may provide API interfaces 640a-640b to merchant and partner-facing products and services, such as including application extensions, process flow services, developer-facing resources, and the like. With customers more frequently using mobile devices for shopping, applications 642a-642b related to mobile use may benefit from more extensive use of APIs to support the related growing commerce traffic. The flexibility offered through use of applications and APIs (e.g., as offered for application development) enable the e-commerce platform 600 to better accommodate new and unique needs of merchants (and internal developers through internal APIs) without requiring constant change to the commerce management engine 636, thus providing merchants what they need when they need it. For instance, shipping services 622 may be integrated with the commerce management engine 636 through a shipping or carrier service API, thus enabling the c-commerce platform 600 to provide shipping service functionality without directly impacting code running in the commerce management engine 636.

Many merchant problems may be solved by letting partners improve and extend merchant workflows through application development, such as problems associated with back-office operations (merchant-facing applications 642a-642b) and in the online store 638 (customer-facing applications 642a-642b). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 642a-642b, through extension/API 640a-640b, help make products easy to view and purchase in a fast growing marketplace. In some embodiments, partners, application developers, internal applications facilities, and the like, may be provided with a software development kit (SDK), such as through creating a frame within the administrator 614 that sandboxes an application interface. In some embodiments, the administrator 614 may not have control over nor be aware of what happens within the frame. The SDK may be used in conjunction with a user interface kit to produce interfaces that mimic the look and feel of the e-commerce platform 600, such as acting as an extension of the commerce management engine 636.

Applications 642a-642b that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 636, such as for synchronizing a local database, notifying an external integration partner, and the like. Update events may enable this functionality without having to poll the commerce management engine 636 all the time to check for updates, such as through an update event subscription. In some embodiments, when a change related to an update event subscription occurs, the commerce management engine 636 may post a request, such as to a predefined callback URL. The body of this request may contain a new state of the object and a description of the action or event. Update event subscriptions may be created manually, in the administrator facility 614, or automatically (e.g., via the API 640a-640b). In some embodiments, update events may be queued and processed asynchronously from a state change that triggered them, which may produce an update event notification that is not distributed in real-time.

In some embodiments, the e-commerce platform 600 may provide application search, recommendation and support 628. Application search, recommendation and support 628 may include developer products and tools to aid in the development of applications, an application dashboard (e.g., to provide developers with a development interface, to administrators for management of applications, to merchants for customization of applications, and the like), facilities for installing and providing permissions with respect to providing access to an application 642a-642b (e.g., for public access, such as where criteria must be met before being installed, or for private use by a merchant), application searching to make it easy for a merchant to search for applications 642a-642b that satisfy a need for their online store 638, application recommendations to provide merchants with suggestions on how they can improve the user experience through their online store 638, a description of core application capabilities within the commerce management engine 636, and the like. These support facilities may be utilized by application development performed by any entity, including the merchant developing their own application 642a-642b, a third-party developer developing an application 642a-642b (e.g., contracted by a merchant, developed on their own to offer to the public, contracted for use in association with the e-commerce platform 600, and the like), or an application 642a or 642b being developed by internal personal resources associated with the e-commerce platform 600. In some embodiments, applications 642a-642b may be assigned an application identifier (ID), such as for linking to an application (e.g., through an API), searching for an application, making application recommendations, and the like.

The commerce management engine 636 may include base functions of the e-commerce platform 600 and expose these functions through APIs 640a-640b to applications 642a-642b. The APIs 640a-640b may enable different types of applications built through application development. Applications 642a-642b may be capable of satisfying a great variety of needs for merchants but may be grouped roughly into three categories: customer-facing applications, merchant-facing applications, integration applications, and the like. Customer-facing applications 642a-642b may include online store 638 or channels 610a-610b that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 642a-642b may include applications that allow the merchant to administer their online store 638 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 612 and payment gateways.

In some embodiments, an application developer may use an application proxy to fetch data from an outside location and display it on the page of an online store 638. Content on these proxy pages may be dynamic, capable of being updated, and the like. Application proxies may be useful for displaying image galleries, statistics, custom forms, and other kinds of dynamic content. The core-application structure of the e-commerce platform 600 may allow for an increasing number of merchant experiences to be built in applications 642a-642b so that the commerce management engine 636 can remain focused on the more commonly utilized business logic of commerce.

The e-commerce platform 600 provides an online shopping experience through a curated system architecture that enables merchants to connect with customers in a flexible and transparent manner. A typical customer experience may be better understood through an embodiment example purchase workflow, where the customer browses the merchant's products on a channel 610a-610b, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 610a-610b. A channel 610a-610b is a place where customers can view and buy products. In some embodiments, channels 610a-610b may be modeled as applications 642a-642b (a possible exception being the online store 638, which is integrated within the commence management engine 636). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 638 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information, such as an email address, billing information, and shipping details. On checkout, the merchant commits to pricing. If the customer inputs their contact information but does not proceed to payment, the e-commerce platform 600 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10,” and entitlements may be items such as “a 20% discount on the whole order” or “$10 off products X, Y, and Z.”

Customers then pay for the content of their cart resulting in the creation of an order for the merchant. Channels 610a-610b may use the commerce management engine 636 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 606 may be provided through a card server environment. In some embodiments, the payment gateway 606 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 636 may support many other payment methods, such as through an offsite payment gateway 606 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 610a-610b that do not rely on commerce management engine 636 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and track quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method that requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the commerce management engine 636 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 600 may make the merchant aware of compliance issues with respect to legal obligations (e.g., with respect to taxes). In some embodiments, the e-commerce platform 600 may enable merchants to keep track of changes to the contract of sales over time, such as implemented through a sales model component (e.g., an append-only date-based ledger that records sale-related events that happened to an item).

In some embodiments, a processor-implemented method comprises obtaining, by a processor associated with an augmented reality device, attribute data associated with a current object in a view of the augmented reality device. Responsive to receiving an instruction indicating an attribute for a comparison of the current object with a comparison object, identifying, by the processor, the comparison object based upon the attribute data associated with the current object; and generating, by the processor, an augmented reality graphical user interface displaying a virtual representation of the attribute of the comparison object in the view of the current object.

In some implementations, generating the augmented reality graphical user interface includes generating, by the processor, an augmented reality overlay for the virtual representation of the attribute to be displayed in the augmented reality graphical user interface. The processor generates the augmented reality overlay based upon the attribute indicated by the instruction.

In some implementations, the method includes generating, by the processor, a second augmented reality overlay for the virtual representation of a second attribute of at least one of the comparison object or the current object; and updating, by the processor, the augmented reality graphical user interface to display a second virtual representation of the second attribute using the second augmented reality overlay for the second attribute.

In some implementations, the attribute data includes one or more attributes, including at least one of: a dimension attribute, a text attribute, or an object type.

In some implementations, the instruction comprises a user gesture indicating the current object for the comparison against the comparison object.

In some implementations, the method includes identifying, by the processor, a text attribute of the current object in image data for the current object by applying an object recognition engine; and recognizing, by the processor, the text in the text attribute of the current object.

In some implementations, the method includes extracting, by the processor, one or more attributes of the attribute data for the current object by applying an object recognition engine on image data for the current object.

In some implementations, the method includes identifying, by the processor, one or more attributes of the attribute data of the current object; and determining, by the processor, the comparison object having the one or more attributes in the attribute data of the comparison object.

In some implementations, the processor compares the one or more attributes of the current object against the one or more attributes of the comparison object in response to identifying the one or more attributes of the current object.

In some implementations, identifying the comparison object includes applying, by the processor, an object recognition engine on image data of the current object to extract one or more attributes of the attribute data for the current object; and applying, by the processor, a selection engine on the attribute of the current object to extract a first feature vector representing the attribute data for the current object satisfying a threshold similarity score to a second feature vector representing the attribute data for the comparison object.

In some implementations, the method includes querying, by the processor, a database of comparison objects previously-viewed by the augmented reality device.

In some implementations, the processor continually captures image data for a plurality of current objects and continually applies an object recognition engine on the image data for the plurality of current objects.

In some implementations, the augmented reality graphical user interface includes an augmented reality overlay of the virtual representation of the attribute of the comparison object in proximity to the attribute of the current object.

In some implementations, the instruction indicating the attribute for the comparison includes a verbal instruction.

In some embodiments a system comprises a processor associated with an augmented reality device. The processor is configured to obtain attribute data associated with a current object in a view of the augmented reality device. Responsive to receiving an instruction indicating an attribute for a comparison of the current object with a comparison object, the processor is configured to identify the comparison object based upon the attribute data associated with the current object; and generate an augmented reality graphical user interface displaying a virtual representation of the attribute of the comparison object in the view of the current object.

In some implementations, when generating the augmented reality graphical user interface, the processor is further configured to generate an augmented reality overlay for the virtual representation of the attribute to be displayed in the augmented reality graphical user interface. The processor generates the augmented reality overlay based upon the attribute indicated by the instruction. The processor is further configured to generate a second augmented reality overlay for the virtual representation of a second attribute of at least one of the comparison object or the current object; and update the augmented reality graphical user interface to display a second virtual representation of the second attribute using the second augmented reality overlay for the second attribute.

In some implementations, the instruction comprises a user gesture indicating the current object for the comparison against the comparison object.

In some implementations, the processor is further configured to identify a text attribute of the current object in image data for the current object by applying an object recognition engine; and recognize the text in the text attribute of the current object.

In some implementations, the processor is further configured to identify one or more attributes of the attribute data of the current object; and determine the comparison object having the one or more attributes in the attribute data of the comparison object.

In some implementations, the processor is configured to compare the one or more attributes of the current object against the one or more attributes of the comparison object in response to identifying the one or more attributes of the current object.

In some embodiments, a non-transitory machine-readable storage medium having computer-executable instructions stored thereon that, when executed by one or more processors, cause the one or more processors to perform operations. The operations comprise obtaining attribute data associated with a current object in a view of the augmented reality device; responsive to receiving an instruction indicating an attribute for a comparison of the current object with a comparison object, identifying the comparison object based upon the attribute data associated with the current object; and generating an augmented reality graphical user interface displaying a virtual representation of the attribute of the comparison object in the view of the current object.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc., are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features of this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A processor-implemented method comprising:
obtaining, by a processor associated with an augmented reality device, attribute data associated with a current object in a view of the augmented reality device;
responsive to receiving an instruction indicating an attribute for a comparison of the current object with a comparison object, identifying, by the processor, the comparison object based upon the attribute data associated with the current object; and
generating, by the processor, an augmented reality graphical user interface displaying a virtual representation of the attribute of the comparison object in the view of the current object.

2. The method according to claim 1, wherein generating the augmented reality graphical user interface includes generating, by the processor, an augmented reality overlay for the virtual representation of the attribute to be displayed in the augmented reality graphical user interface, wherein the processor generates the augmented reality overlay based upon the attribute indicated by the instruction.

3. The method according to claim 2, further comprising:
generating, by the processor, a second augmented reality overlay for the virtual representation of a second attribute of at least one of the comparison object or the current object; and
updating, by the processor, the augmented reality graphical user interface to display a second virtual representation of the second attribute using the second augmented reality overlay for the second attribute.

4. The method according to claim 1, wherein the attribute data includes one or more attributes, including at least one of: a dimension attribute, a text attribute, or an object type.

5. The method according to claim 1, wherein the instruction comprises a user gesture indicating the current object for the comparison against the comparison object.

6. The method according to claim 1, further comprising:
identifying, by the processor, a text attribute of the current object in image data for the current object by applying an object recognition engine; and
recognizing, by the processor, the text in the text attribute of the current object.

7. The method according to claim 1, further comprising extracting, by the processor, one or more attributes of the attribute data for the current object by applying an object recognition engine on image data for the current object.

8. The method according to claim 1, further comprising:
identifying, by the processor, one or more attributes of the attribute data of the current object; and
determining, by the processor, the comparison object having the one or more attributes in the attribute data of the comparison object.

9. The method according to claim 8, wherein the processor compares the one or more attributes of the current object against the one or more attributes of the comparison object in response to identifying the one or more attributes of the current object.

10. The method according to claim 1, wherein identifying the comparison object includes:
applying, by the processor, an object recognition engine on image data of the current object to extract one or more attributes of the attribute data for the current object; and
applying, by the processor, a selection engine on the attribute of the current object to extract a first feature vector representing the attribute data for the current object satisfying a threshold similarity score to a second feature vector representing the attribute data for the comparison object.

11. The method according to claim 1, further comprising querying, by the processor, a database of comparison objects previously-viewed by the augmented reality device.

12. The method according to claim 1, wherein the processor continually captures image data for a plurality of current objects and continually applies an object recognition engine on the image data for the plurality of current objects.

13. The method according to claim 1, wherein the augmented reality graphical user interface includes an augmented reality overlay of the virtual representation of the attribute of the comparison object in proximity to the attribute of the current object.

14. The method according to claim 1, wherein the instruction indicating the attribute for the comparison includes a verbal instruction.

15. A system comprising:
a processor associated with an augmented reality device and configured to:
obtain attribute data associated with a current object in a view of the augmented reality device;
responsive to receiving an instruction indicating an attribute for a comparison of the current object with a comparison object, identify the comparison object based upon the attribute data associated with the current object; and
generate an augmented reality graphical user interface displaying a virtual representation of the attribute of the comparison object in the view of the current object.

16. The system according to claim 15, wherein, when generating the augmented reality graphical user interface, the processor is further configured to:
generate an augmented reality overlay for the virtual representation of the attribute to be displayed in the augmented reality graphical user interface, wherein the processor generates the augmented reality overlay based upon the attribute indicated by the instruction;
generate a second augmented reality overlay for the virtual representation of a second attribute of at least one of the comparison object or the current object; and
update the augmented reality graphical user interface to display a second virtual representation of the second attribute using the second augmented reality overlay for the second attribute.

17. The system according to claim 15, wherein the instruction comprises a user gesture indicating the current object for the comparison against the comparison object.

18. The system according to claim 15, wherein the processor is further configured to:
identify a text attribute of the current object in image data for the current object by applying an object recognition engine; and
recognize the text in the text attribute of the current object.

19. The system according to claim 15, wherein the processor is further configured to:
identify one or more attributes of the attribute data of the current object; and
determine the comparison object having the one or more attributes in the attribute data of the comparison object.

20. The system according to claim 19, wherein the processor is configured to compare the one or more attributes of the current object against the one or more attributes of the comparison object in response to identifying the one or more attributes of the current object.

21. A non-transitory machine-readable storage medium having computer-executable instructions stored thereon that, when executed by one or more processors, cause the one or more processors to perform operations comprising:
obtaining attribute data associated with a current object in a view of the augmented reality device;
responsive to receiving an instruction indicating an attribute for a comparison of the current object with a comparison object, identifying the comparison object based upon the attribute data associated with the current object; and
generating an augmented reality graphical user interface displaying a virtual representation of the attribute of the comparison object in the view of the current object.
